(19) United States
(12) Patent Application Publication
(10) Pub. No.: US 2003/0163779 A1
(43) Pub. Date: Aug. 28, 2003

(54) Administrative control for data views

(76) Inventor: Peter Warren, Cannes (FR)

Correspondence Address: GREENBERG-TRAURIG, 1750 TYSONS BOULEVARD, 12TH FLOOR, MCLEAN, VA, 22102, US

(21) Appl. No.: 10/327,089

(22) Filed: Dec. 24, 2002

Related U.S. Application Data
(63) Continuation-in-part of application No. 09/712,581, filed on Nov. 13, 2000.
(63) Continuation-in-part of application No. 09/710,826, filed on Nov. 13, 2000.
(63) Continuation-in-part of application No. 10/227,449, filed on Aug. 26, 2002.

(51) Int. Cl. G06F 15/00

(52) U.S. Cl. 715/500

(57) ABSTRACT

A system for implementing administrative control functions in association with views for data items in which the host computer stores the definition of the administrative control function with reference to a view for a data item. Then, in response to a subsequent user command selecting the view, the host computer implements the administrative control function in association with the view. The view, including the administrative control function, may be created and implemented during an uninterrupted user session, and may be transmitted to a compatible computer system where is received, stored and implemented during an uninterrupted user session. The administrative control functions may be defined in database records referenced to one or more views, and may be implemented by processing those records during an uninterrupted user session.

### REFERENCE TO RELATED APPLICATIONS

This application is a continuation-in-part claiming priority to commonly-owned U.S. patent application Ser. No. 09/712,581 entitled “Any-To-Any Component Computing System,” commonly-owned U.S. patent application Ser. No. 09/710,826 entitled “Graphical User Interface” and commonly-owned U.S. patent application Ser. No. 10/227,449 filed on Aug. 26, 2002 entitled “Dynamic Data Item Viewer” the entire disclosures of which, including the appendices thereto, are incorporated herein by reference.

### REFERENCE TO APPENDIX

This application incorporates by reference the material contained in the appendix to U.S. patent application Ser. No. 10/227,449.

### TECHNICAL FIELD

This invention relates to computer software and, more specifically, relates to a dynamic data item viewer that implements administrative control for views of database items.

### BACKGROUND OF THE INVENTION

The capabilities of software constructed with conventional approaches are inherently limited due to the fundamental nature in which the software is constructed. In particular, virtually every type of conventional software is constructed as one or more large masses of executable code that is written in one or more source code files, which are compiled into one or more executable files, which typically produce interrelated output data of various types. The format of the output data, and the screen displays rendered by the software for showing the output data, are integrally controlled and set up by the executable code, which may further involve integral cooperation with facilities provided by the operating system and other applications, such as commonly-accessed objects, DLLS, device drivers, and the like. Once compiled, the executable files can run on an appropriately equipped computer system to implement the pre-configured functionality and render the pre-configured output screens. But the resulting software infrastructure is inherently limited because it is very difficult to vary software constructed in this manner from the pre-configured functionality originally built into the software. This is a systemic problem with the conventional software infrastructure, which currently limits the ability of this infrastructure to progress in an evolutionary manner.

Specifically, once a particular application has been written and compiled in the conventional manner, the functionality of the application is inherently limited to the functions that the developers anticipated and built into the executable files. Any change to the pre-configured code, or the data structures, or the visual output capability, requires digging into the original source code, writing programming changes at the source code level, debugging and testing the altered code, and recompiling the altered code. Once this task has been completed, the software application is again limited to the functionality that the developers anticipated and built into the updated executable files. But the updated executable files are just as inaccessible to the user as the original files, which again limits the functionality of the software to the functionality built into the newly updated executable files.

As any software engineer can attest, the process of updating conventional software in the manner described above becomes increasingly difficult as the software becomes increasingly sophisticated. Even conceptually simple tasks, such as implementing software changes while maintaining backward compatibility with files created using earlier versions of the same software, can become vexingly difficult and in some cases technically impractical or economically infeasible. Indeed, the “Y2K” programming challenge taught the industry that implementing any type of programming change to conventional software, no matter how conceptually simple, can draw the programmers into a nearly impenetrable morass of interrelated instructions and data structures expressed in a complex system of executable files that typically cannot share information or functional capabilities with each other without tremendous effort.

In general, this programming inflexibility ultimately results in limitations imposed on the sophistication of software, limitations imposed on the ability to integrate existing applications together into cooperating units, and limitations imposed on the scope of potential users who can effectively use virtually any type of software built using the current infrastructure. As a result, much of the world remains computer illiterate, while the remainder struggles to deal with the current system, which includes a staggering number of enormously complex executable files. In addition, recent increases in computer hardware capabilities remain substantially underutilized because conventional software cannot effectively be extended to take advantage of the new computing capabilities. The end results include hardware and software industries that both appear to be stymied, waiting for a solution that will allow significant progress to proceed on both fronts.

From a more personal point of view, the conventional software infrastructure effectively shifts serious burdens from the software (or, more correctly, from the programmers who wrote the software) onto those persons least equipped to deal with them, such as new users trying to learn how to use the programs. This occurs because the programmers must necessarily develop a system of documentation to assist the users in understanding how to use the software, which is an expensive undertaking that generally increases with the amount of documentation provided. The most expedient approach often involves creating the least amount of documentation that one can reasonably be expected to get away with in the current market, and letting the users “fend for themselves” or buy a different product.

For example, one type of help documentation includes pop-up user interface screens that display text-based help items “on the fly” under the control of the underlying software. However, due the limited size of the display screen, the amount of information that can be communicated in this manner is very limited. This limitation is exacerbated when the display screen is very small, as occurs with hand-held PDA devices, wireless telephones, and the like. In addition, too many help screens that pop-up automatically without user control can be an annoying impediment. Although menu-driven help screens can decrease the reliance on automatic pop-up screens, they can be cumbersome and time consuming to use. To make matters worse, the prevailing market forces apparently dictate that inexpensive small-screen computing devices come with the thinnest, most puzzling types of printed and on-screen documentation. In sum, the shortcomings of conventional help documentation appear to present a formidable near-term barrier to bringing inexpensive small-screen computing devices to much of the computer-illiterate world. Unfortunately, this condition may significantly delay the realization of very widespread distribution of inexpensive computing devices with the capacity to bridge the technology gap that currently separates the computer “haves” from the computer “have-nots.”

Moreover, because the same automatic user interface screens are necessarily displayed for all users regardless of their familiarization with the software, these on-screen displays are usually limited to displays that “most” users find “most” helpful “most” of the time, which are all too often incomprehensible to the newcomer and inadequately specific for the expert. For more detailed information, the user must resort to other less obvious resources, such as menu-driven help documentation or printed manuals. In general, these resources are notoriously cryptic, and remain so despite the best intentions of many highly skilled authors. For example, although some of these resources are “context sensitive,” they may still be inadequately germane to a particular matter at hand, especially when that matter was not fully anticipated by the author of the documentation. Even when assisted by probability or other conventional mechanisms, these resources often miss the mark so badly as to be nearly useless—typically when the user needs them most. Partly as a result of these systemic limitations, new users are often intimidated from getting started with new software programs, and many sophisticated functions built into the software programs remain unused, even by long-time users.

Another important practical effect of the limitations experienced by conventional software appears when a user or developer would like to translate an application into a foreign language. Because much of the text displayed by the application is embedded within executable files, a commercially viable set of labels, prompts, messages and help screens cannot be translated into another language without digging into the source code, changing the text at this level, and then recompiling the code. For a sophisticated software application, this process can be extremely time consuming, expensive and difficult, and generally requires an expensive team of highly skilled programmers to complete. As a result, it is impractical or economically infeasible to translate many types of software into a very wide selection of languages that would ensure its greatest use. For this reason, many software applications remain limited to their original human language, and even when an application is translated, it is typically limited to the world's four or five most-used languages. This limits the markets for these products, which deprives much of the world from the benefits that it could enjoy from access to powerful software applications.

To illustrate another practical limitation of conventional software, consider an organizational environment in which part of a document, such as an accounting spreadsheet or briefing document, is required reading for certain employees while other parts of the document contain confidential information that is off-limits to those same employees. One attempted solution for this conundrum involves creating different versions of the same document suitable for distribution to different users. This approach immediately multiplies the complexity of document management and brings into play challenging problems, such as having to store multiple versions of the same document, having to keep multiple versions of the same document coordinated with a base version that changes continually, and so forth. If the document contains sophisticated code and large amounts of data, the resources required to store and maintain duplicate copies can be a significant factor.

Moreover, regardless of the resource requirements, the administrative difficulties can become extreme when the objective is to make extremely sensitive information available in accordance with an intricate system of access rules. Common examples of these types of applications include financial accounting systems and security clearance-based access systems. In these situations, the only cost effective way to ensure an adequate level of confidentiality may be to implement a document management system that prevents all of the software, or all of its data, from being accessed by anyone except a very limited number of “authorized” persons. At the same time, however, it would be far more efficient if appropriate portions of the application could be freely accessed by a variety of “non-authorized” or “partially-authorized” persons.

In the current state of the art, an additional conundrum occurs when different persons in an organization need to be able to do different things to a particular type of data. For example, several different persons may have a need to perform different activities using a particular type of data. Prior attempts to solve this problem include the development of commonly-accessed spreadsheets, in which certain cells of the spreadsheet, or the entire spreadsheet, can be “locked” and only accessible via a password. Unfortunately, this type of functionality is not generally available to the users of other application programs, such as word processing, presentation software, database software, and the like. Moreover, even in the spreadsheet programs containing this type of functionality, the solution has thus far been so inflexible that the ability to make changes to a particular spreadsheet is either black or white. That is, the only available choices are to allow a particular user to change all the data and functions in the spreadsheet, or to make that user unable to input any changes at all.

This problem is only the tip of the iceberg, because it is only one aspect of the control of security. Because of the nature of today's software construction where the data is most generally stored as a file whose structure is related to the software that created it, in the absence of any implementation of security and permissions in the software concerned, there is little to be done about who can do what to a file other than control at the coarsest—system—level. In this method, control of the data is limited more or less to general aspects such as whether or not the data is ready only and who can have access to the directory concerned. However, different software can potentially perform a vast variety of different things to any given data and, at least in some applications, a practical methodology for being able to designated who can do exactly which of the basket of available activities to precisely which part of any given data is a flexibility that does not exist in today's world, and especially is unavailable in almost any form to those without specialist training.

To make matters worse, it is very difficult to resolve this problem in current software programs because the inability of these programs to make data and functionality available on a user-by-user or item-by-item basis is deeply rooted in the programs at the source code level, and therefore has little or nothing to do with the type or sensitivity of the data produced or maintained by the software. As an example of this problem, consider a briefing document that contains some confidential parts and other non-confidential parts suitable for public consumption. In this example, the organization controlling the document may want its staff to read the entire briefing, but does not want any of the confidential parts to be sent to outsiders. At the same time, the organization may have a policy the permits outsiders to read the non-confidential parts of the document, for example in response to a valid Freedom of Information Act request. Typically, a word processing program or an e-mail program can either send out everything it can access, or can't send out anything. Hence, if an employee reads such a document using his word-processing software, he can also send it out by e-mail, which can undermine attempts to control subsequent distribution of the document and lead to considerable embarrassment for those concerned.

This problem occurs because conventional software is limited in that it cannot make individual elements of data or functionality available, or unavailable, on a user-by-user or item-by-item basis. For example, in the situation discussed above, a particular briefing created for public consumption cannot contain any confidential data, while a briefing on the same subject matter containing a relatively small amount of confidential information must be restricted to a small class of authorized persons. In very high-security environments, the only practical way to deal with this problem may be to create an “air-wall” in which the internal system has no connection to the outside world whatsoever, which causes additional problems including inefficiencies at the human level.

Despite an enormously expensive training and support infrastructure that has developed around the conventional software industry, the promise of increasingly sophisticated software remains constrained by steep learning curves, ineffective documentation, inadequate and overly expensive training options and long and expensive deployment cycles. Consider again the accounting example in which a salesman should certainly be able to see if his client's payment has arrived, but he cannot because he is not fully “authorized.” The root cause of this problem lies in the inflexibility of the underlying software, and the only practical alternative to fixing the software effectively shifts the cost of the problem onto the humans involved, in this example by requiring the salesman to expend considerable time “talking to the accounts department” to obtain data that ought to be freely available to him in the first place. Not only does this so-called solution waste the salesman's time, it also disturbs at least one other person working in the accounts department. Eventually, entire job descriptions center around tasks created by software programs. Put somewhat differently, the current software infrastructure shifts very significant burdens onto the humans involved, rather than the other way around, which is serious problem indeed.

Therefore, a need exists for an improved paradigm for constructing software that overcomes the inherent limitations of the conventional software infrastructure. A further need exists for improved methods for controlling the exposure of data and functionality of software on a user-by-user, item-by-item and within-item basis. And a further need exists for incorporating helpful instructional capabilities into software that can be effectively targeted to particular matters that confront users of all skill levels.

### SUMMARY OF THE INVENTION

The present invention contributes to a new software paradigm that meets the needs described above in a method for displaying different views of data items, as well as making different selections of functionality available for a particular view, on a user-by-user basis. In addition, different user-customized views of data items may be constructed during uninterrupted user sessions, and may be exchanged between users during uninterrupted user sessions. Thus, multiple users may define, store and access multiple views of any type of data item “on the fly,” which greatly improves the capabilities and understandability of any application implemented on the host computer. For example, any user may define, store and access multiple views of any type of data item “on the fly” to create customized platforms for a virtually unlimited range of purposes, such as implementing language translation, creating training platforms, displaying helpful items in a user's own words, incorporating explanatory information into views, incorporating helpful instructional information into views, customizing views for special purposes, customizing views for other persons, adapting existing views for alternative uses, and so forth.

Generally described, the methodology of the invention may be implemented on a host computer system, which may be local or remote, or it may be expressed in computer-executable instructions stored on a computer storage medium. The host computer system provides a view for displaying a data item, and receives user commands defining an administrative control function to be performed in association with the view. The host computer stores the definition of the administrative control function with reference to the data item and, in response to a subsequent user command selecting the data item, the host computer implements the administrative control function in association with the view. These steps may be implemented during an uninterrupted user session, and the administrative control function may be defined by the user to be automatically implemented upon selection of the view.

The administrative control function may also be implemented in association with a view for displaying the data item. The view may be defined by the user and stored in database records “on the fly,” or it may be provided as a pre-configured item along with the database. In either case, the host computer may store the definition of the administrative control function in one or more database records referenced to the view for the data item and, in response to a subsequent user command selecting the view, the host computer implements the administrative control function in association with the view. Again, these steps may be implemented during an uninterrupted user session, and the administrative control function may be defined by the user to be automatically implemented upon selection of the view.

The administrative control function may involve controlling the ability of the identified users to view or change aspects of the view, defined on an item-by-item, field-by-field, user-by-user, group or global basis, or combinations thereof. In addition, the administrative control function may involve the administration of encryption associated with transmission of the view, and the ability to do anything with the data being shown by the view, such as print it, e-mail it, archive it. The encryption function may also be defined on an item-by-item, field-by-field, user-by-user, group or global basis, or combinations thereof.

To implement component processing, the database records defining the administrative control function may incorporate data components that cannot be subdivided without losing the entirety of the meaning of the original data. Similarly, the database records defining the administrative control function may incorporate executable code components that cannot be subdivided without losing the entirety of the useful functionality of the original code. The database records defining the administrative control function may also include sets of related data and software records expressed in field parallel format or in list record format. The host computer may also transmit the database records defining the view and the administrative control function to another computer having a compatible set of executable code components. Then, during an uninterrupted user session, the receiving computer may receive the database records defining the view and renders the view and implements the administrative control function.

In view of the foregoing, it will be appreciated that the present invention avoids the drawbacks of methods for viewing data items in a computer system and provides a more effective and flexible method for creating customized views of data screens. The specific techniques and structures employed by the invention to improve over the drawbacks of prior systems for viewing data items in a computer environment and accomplish the advantages described above will become apparent from the following detailed description of the embodiments and the appended drawings and claims.

### BRIEF DESCRIPTION OF THE DRAWINGS

FIG. 1 is a functional block diagram of a computing system in which the present invention may be implemented.

FIG. 2 is a user interface display illustrating a pre-configured view for displaying a data item.

FIG. 3 is a user interface display illustrating a message displayed in connection with a pre-configured view for displaying a data item.

FIG. 4 is a user interface display illustrating a help item displayed in connection with a particular part of a pre-configured view for displaying a data item.

FIG. 5 is a user interface display illustrating an active element editor for altering a pre-configured view for displaying a data item.

FIG. 6 is a user interface display illustrating a user-defined view for displaying a data item.

FIG. 7 is a user interface display illustrating a user-defined message displayed in connection with a user-defined view for displaying a data item.

FIG. 8 is a user interface display illustrating a user-defined help item displayed in connection with a user-defined view for displaying a data item.

FIG. 9 is a user interface display illustrating a utility for naming and saving a user-defined view for displaying a data item.

FIG. 10 is a user interface display illustrating a utility receiving a name for a user-defined view for displaying a data item.

FIGS. 11A and 11B are user interface displays illustrating a default view and a user-defined view for displaying a data item.

FIGS. 12A and 12B are block diagrams illustrating a data structure for storing definition information for a default and a user-defined view for displaying a data item.

FIG. 13 is a user interface display illustrating a utility for selecting a view for displaying a data item.

FIG. 14 shows several user interface displays illustrating a selection utility allowing multiple users to select among multiple views for displaying a data item.

FIG. 15 shows several user-defined view selection utilities having different visual attributes selected by the corresponding users.

FIG. 16A is a user interface for adding an animation to a view.

FIG. 16B is a user interface for adding an administrative control function to a view.

FIG. 17 is a block diagram illustrating a data structure for storing definition information for a view including an animation, an executable activity, and an administrative control function.

### DETAILED DESCRIPTION OF THE EMBODIMENTS

The present invention includes a dynamic item manipulator that may be embodied in applications constructed using a new software paradigm known as an EXOBRAIN™ system. This trademark, which is owned by ExoBrain, Inc. of Chattanooga, Tenn., refers to an any-to-any component computing system as described in U.S. patent application Ser. No. 09/712,581, and a related graphical user interface as described in U.S. patent application Ser. No. 09/710,826, which are incorporated by reference. This system is further described in the files contained on the appendix to U.S. patent application Ser. No. 10/227,449, which is also incorporated by reference. The appendix includes a descriptive table illustrating the structure and functionality of a data relation table (DRT) along with several text files describing the construction and use of the DRT in implementing an EXOBRAIN system. It is important to appreciate that in an any-to-any machine, every type of data item, even one as elemental as a single letter, may be represented in fields contained in the DRT. While this aspect of the embodiments described below facilitates the implementation of the invention, this does not in any way limit the scope of this invention to an any-to-any machine.

The embodiments of the invention may be implemented on a host computer system, which may be local or remote, or they may be expressed in computer-executable instructions stored on any suitable type of computer storage medium. In this context, a “host computer system” refers either to a local computer at which a person is working, or to a remote computer that stores the data, stores the software, stores the input/output control information, controls the local system, or performs some other function involved in the implementation of the methodology, or to combinations thereof. In particular, the claimed invention should be considered to have been practiced wherever the benefit of the invention is enjoyed, regardless of whether one or more of the constituent steps or devices were performed or located in a jurisdiction in which the invention is not patented, such as outer space, a country without a patent system, or a country where patent protection has not been secured. Similarly, the claimed invention should be considered to have been practiced wherever a substantial portion of the constituent steps or devices were performed or located, regardless of whether the totality of the claimed steps or devices were performed or located in multiple jurisdictions having disparate patent laws. Notwithstanding this potential computing environment complexity, the following minimum and recommend system requirements are presently considered appropriate for the basic functionality included in the current embodiments of the EXOBRAIN system: For a normal office application the minimum system requirements for EXOBRAIN implemented in Java are 200 MZ processor, 128 MB RAM, 5 GB disk. Recommended system is 1 GZ processor, 512 MB RAM, 10 GB disk. For Mobile applications the minimum system is 64 MB RAM, 256 MB of storage and a processor capable of running Linux.

In the context of the invention, a “view” is defined as a human perceptible representation of all or part of a data item and typically includes associated effects, such as an image, sound, animation, executable activity, or associated property. Thus, a view may include all of a particular data item or a combination of parts of that data item, and may include properties governing the appearance and functionality of the item. A view may include “pre-configured” elements defined prior to a current user session, and may also include “user-defined” elements defined during a current user session. Accordingly, the term “pre-configured” means data or functionality that was incorporated into a software structure prior to a current user session, either by prior programming or by prior user input creating user-defined data items using the tools and structures implemented by the prior programming. Moreover, the term “pre-configured” as applied to a data item also encompasses the null set, in which the pre-configured construct is a blank or empty item. In addition, the term “uninterrupted user session” means that the host computer system performs the recited method “on the fly” during a continuous and substantially uninterrupted user session without having to recompile the underlying code, reboot the system, restart the software, reload the view, or otherwise interrupt the user's interaction with the host computer system in a substantial way.

The customizable features of a view may include the selection of fields and functionality made available within a particular view, and may also include administration information controlling access to the items included on the view, such as the ability of users to view or change individual data items defined item-by-item, user-by-user, or on a group or global basis. The administration information may also include encryption, other security features, and other executable activities that may be defined field-by-field, item-by-item, user-by-user, or on a group or global basis. Further, the customizable features of a view may also include the selection of visual features associated with data items, such as borders, shapes, and backgrounds for view areas, as well as the selection of other effects, such as text features that may be displayed or played in connection with a data item, such as a label, prompt, message, tool tip, help item, and the like. In addition, the ability to access or make changes to a particular view, or to a constituent item of a view, or to any effect associated with a view or item within a view, are also administrative effects that can be defined field-by-field, view-by-view, item-by-item, effect-by-effect, user-by-user, or on a group or global basis.

In the context of a view, the term “effects” is used as catch-all term that includes administrative properties, as described above, as well as all types of features implemented within labels, prompts, help screens, tool tips, pop-up messages, and all other features that may be associated with a data item. For example, effects include all types of information conveyed from the host computer to the user through any form of user-detectable element of communication. Specifically, effects may include visual and audible items, such as text, images, animation, sound and executable activities that act to assist the user's understanding of the data, the software, other users, or some other relevant factor. For example, an effect may inform a user about data that he is expected to input or will receive as an output, or about a user or system that the user is communicating with, or about administration security features implemented in a view. An effect may be conveyed though visual and audible mechanisms, such as words, still or moving images, sounds, lines, arrows, boxes, or the like, such that the effect is to assist the user's understanding of the situation. Any of these items may include text in any font, size, color and style selected by the user, and may also include multi-media features such as images, sounds, animations, or executable activities that are performed in connection with the data item.

Effects may also involve executable activities and other features that may or may not be immediately apparent to the user, such as the execution of activities or the activation or deactivation of software functionality. For example, an effect may include the activation or deactivation of the ability to e-mail the item, the activation or deactivation of the ability to print the item, the execution of an activity performed by the view and displayed to the user, the execution of an activity executed in background, etc. By way of illustration, a view may be associated with an activity defined by the user to be automatically implemented upon selection of the view or an element of the view, such as a look-up and display activity, a link and display activity, a compute and display activity, or any other type of available activity defined by the user. In addition, multiple data items may be combined into a single view, and views may be shared, e-mailed, and exchanged with other users. This usefulness of this feature is further enhanced because a particular view or set of views can be exchanged with another user, who can receive, access and use the view during an uninterrupted session.

Although this invention is described in relation to visual input and output, the mechanisms described are not necessarily an inherent part of either the software that manipulates the data concerned or of the graphical user interface (GUI). Accordingly, the various software components and structures described herein may be implemented separately or in combination with each other. Further, the mechanisms described in this specification are equally applicable and able to control those of the described features applicable to non-visual input and outputs, such as tactile input and outputs, verbal input and output (such as text to speech and voice recognition), and to inputs and outputs between machines, and to any operative combination of these though further and obvious software mechanisms may be required to take advantage of the described abilities under those circumstances. Accordingly, where the word “display” is used in the description that follows, this should be interpreted in its broadest sense to include audio, visual and other human-detectable or machine-detectable modes of communication, as well as the acts of showing, playing, performing or executing any sort of data or instruction, or any combination or permutation of these.

It should also be understood that, although the following description explicitly concerns the example of altering a view containing pre-configured display items, the same techniques may be used to create such an item and its display in the first place. In view of this factor, the concept of a pre-configured display item encompasses the null set, in which the pre-configured construct is a blank or empty item. That is, the principles of the invention may be used to create the first and initial view of an item—effectively creating that new item type as well as to alter previously created views. In addition, a pre-configured view may be constructed by programmers and included as part of the code supplied to a user, or they may be created or altered by users through the use of the functionality and structures included in the underlying programming. Nevertheless, it should be understood that all views, typically without exception, may be changed “on the fly” through user input. Thus, programmer-created views, and views created by non-programmer designers for a company commercializing software, are an optional, but not an essential, part of the product to be delivered to a user.

In addition, the host system, which may include local and remote components, stores the user-defined views for subsequent access, and displays the data items in association with the user-defined views, without the need for additional programming changes. This computing infrastructure is fundamentally different from today's software infrastructure, in which at least one view must be created by a programmer and rendered by the executable code. In addition, a default view is typically defined for a particular type of data item, and since the flexibility available has the capacity to allow the item to be distorted beyond recognition or use, typically, this default view (as well as any others) can by “locked” so that it cannot be removed or changed by an inexperienced or unauthorized person. However, the presence or absence of any particular data that is present in a particular view does not in any way affect the underlying data that may be there. Conventionally, and especially in existing database software, removing a field from visibility in a table can result in the loss of the data that had been stored in the removed. But this is not the case with the dynamic item manipulator, in which the view of the data—for example the selection of particular fields that is visible—has no effect on the existence or otherwise of the underlying data. In fact, it is also possible to arrange the system so that, within a given view, some parts of the data—for example, a particular selection of fields—is visible while another combination of fields that is not visible (but which may also include any of the visible fields) is being used to specify the data shown in the visible field selection. In conventional Query By Example (QBE) implementations, the fields used to query by an example are typically the same as the fields in which the result of the query is shown. In the dynamic item manipulator system, on the other hand, that limitation does not have to occur. For example, two or more different views of the data may be displayed simultaneously, one of which may be used as the QBE input, while the other view may display the results of the QBE query with the field selection or the targeted record type/s or both may be different in each.

Further, the host system may also display a user-accessible selection utility for selecting among the default view and other user-defined views. The host system then receives a selection command in association with the user-accessible selection utility indicating a selected view among the default and the user-defined views and, in response, displays the data item in association with the selected view. Of course, the user-accessible selection utility may itself be constructed as a user-configurable view in the manner described, and hence can be subject to the same customization flexibility that is applicable to any other view. For example, the user-accessible selection utility may itself be configured in the form of different views that the user can select, and the available views may be configured by the user to be suitable to the particular series of customizations he wishes to perform at the time. This is possible because the selection utility itself may be constructed in the form of data, the data in this case being the buttons that represent the various functionality it offers. The utility itself, or any view of data, can be switched to automatically display the utility or a view of particular data either with a view that is the view most recently accessed by the user or with a particular view no matter what view was last used.

The dynamic item manipulator may be implemented for one user, as described above, or it may be implemented for multiple users. That is, the host system may receive a first set of user commands associated with a first user defining a first user view for the data item, and store the first user view in association with an identifier corresponding to the first user. The host system may then receive a second set of user commands associated with a second user defining a second user view for the data item, and store the second user view in association with an identifier corresponding to the second user. The host system may also display a first user-accessible selection utility configured for the first user for selecting among the default view and the first user-defined view, and may also display a second user-accessible selection utility configured for the second user for selecting among the default view and the first user-defined view. In response to detecting that the first user is currently requesting access to the data item, the host system may be configured to display the first user-accessible selection utility and that users preferred view of the data. Similarly, in response to detecting that the second user is currently requesting access to the data item, the host may be configured to display the second user-accessible selection utility and the second user's view/s and or preferred view of the data.

The user-configurable elements of view may include any combination of a label displayed adjacent to a display of the data item, a prompt displayed outside or inside a field in which the data item is displayed, the prompt being replaced by the data item after an initial period of display, or when data is entered, one or more messages displayed or played in association with the data item, one or more pop-up help items selectively displayed or played in association with the date item, one or more shapes associated with the display of the data item, one or more border shapes associated with the display of the data item, one or more backgrounds associated with the display of the data item, and one or more sounds, images, animations or one or more activities including executable steps. Further user configurable elements of a view may include ability to group or ungroup items with other items into the existing or a new view, to add or remove animations, to add or remove fields, to add or remove images as backgrounds to any element in the view including to the view itself, to add or remove user messages, to add or remove any available functionality such as email or lookup functionality and to create, add or remove a new type of record that is then part of that view, to propagate changes made to one view to other elements in that view or in other views, to turn help on or off, and to control other functionality in the view as well as to change such factors as the color, or where appropriate, the thickness of something, for example, of a border.

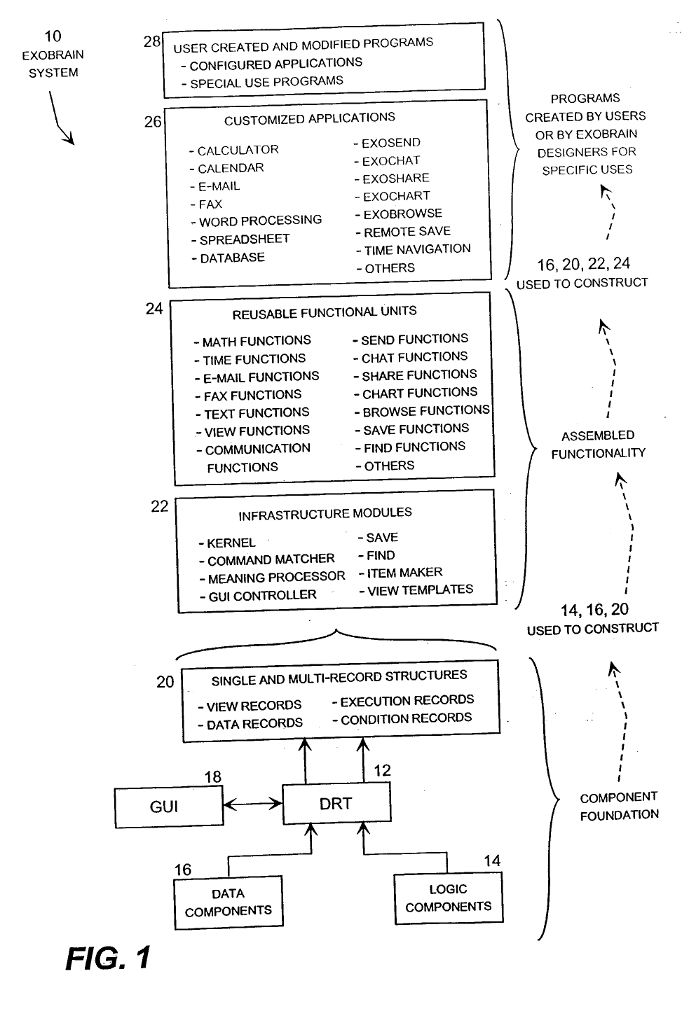

FIG. 1 is a functional block diagram of an EXOBRAIN system 10, in which the dynamic item manipulator may be implemented. The fundamental elements of the EXOBRAIN are a data relation table (DRT) 12, a set of logic components 14, a set of data components 16, and a graphical user interface 18. The DRT 12 includes a database of records and accompanying functionality specifications in which the structure and methods of the EXOBRAIN system may be implemented. In particular, data and logic may be incorporated into individual DRT records through functionality specifications that may be implemented through administration fields and a data class structure that cooperate with each other to implement a universal interface for recording, accessing, and manipulating any type of data, and implementing any type of software, within the EXOBRAIN system 10. Thus, all applications create in the EXOBRAIN system 10 share a common infrastructure and interface, and may therefore communicate with each other without interface-imposed or data structure-imposed boundaries. In addition, the data components 16 may be expressed in a form in which each data component has unambiguous meaning and cannot be subdivided without losing the entirety of the original meaning of the data. Similarly, the set of logic components 14 may be expressed in a form that cannot be subdivided without losing the entirety of the useful functionality of the original code. With this design preference, the data and executable code components are truly atomic in nature, which avoids redundancy in the system to the greatest extent possible provided that the system provides for reuse of such components, for example by using them each time as a reference. In addition, the database records may incorporate data and executable code components that are located outside the database.

To implement software, the records in the DRT 12 may incorporate compiled software components either directly or by reference to the stored logic components 14, which are a set of compiled software components that can be assembled into higher-level functional units within the DRT structure. Nevertheless, the DRT 12 may also store or reference un-compiled code, which can be compiled “on the fly” using functionality implemented within the DRT structure. In a similar manner, the DRT 12 may incorporate data components either directly or by reference to the stored data components 16, which may be assembled into higher-level data units within the DRT. Although they are shown as external to the DRT 12 in FIG. 1, all types of data, including the logic components 14 and the data components 16, as well as infrastructure modules 22, reusable functional units 24, customized applications 26, user created and modified programs 28 and GUI code 18 may be stored within the DRT and an EXOBRAIN functions best and is most flexible if so stored. For descriptive convenience, however, these items and the logic components and the data components may be referred to or illustrated as items that are separate from the DRT, which is a viable (but merely illustrative) embodiment of the EXOBRAIN system 10.

The graphical user interface (GUI) 18 and the GUI controller 22 collectively provide a mechanism for converting human-communicated data and instructions into DRT format, and for converting DRT-housed data and instructions into human perceptible forms. For example, the GUI controller 22 may drive a conventional computer screen and associated peripheral devices. As noted above, the data class and administration field structure of the DRT 12 create a universal data classification system that allows data and software components to be stored in fields of DRT records. In particular, a component may be included in a field of a DRT record by including the substantive data or software element itself in the DRT record, or by including a pointer in the DRT record. This pointer, in turn, may identify the substantive data or software element, or it may identify another pointer that ultimately leads to the substantive data or software element. In other words, a substantive data or software element that is located outside a DRT record may be incorporated into the DRT record by reference. It should be appreciated that, in the any-to-any system, software components are simply treated as another, specialist form of data. As such, software may be incorporated into a DRT record just like any other type of data. The only difference is that a DRT record containing a software component allows the substantive code to execute when the DRT record is processed, whereas a DRT record containing a data component presents the substantive data elements for manipulation when the DRT record is processed.

Whether data or software, the presence of a particular component in a particular field of a DRT record may be used to relate that component to other components located in the same field in other DRT records. This principle of relating data items to each other based on field location or storage pattern similarity is referred to as a “field parallel” record structure. In other words, a field parallel record structure involves locating components in the same field of different DRT records to connote a relationship between the components. The relationship implied by the field parallel record structure may, in turn, be considered when implementing operations utilizing both components while, at the same time, keeping each component entirely separate from the other in individual records. In addition, the individual records containing components that “go together” may be referenced in a third record, such as a list record. For example, a particular software record may go with a particular set of data records, or a mixture of software and data records. Notwithstanding this operational relationship among the records, none of the records or the data they contain necessarily become part of a programmer-coded construction entity, as would occur in conventional software. This is because the relationships between the components is expressed in the DRT 12 rather than in the compiled code, and the DRT is a database that may be freely manipulated by the user without having to alter the underlying compiled code.

As a result, higher-level software applications may be implemented within the DRT 12 by referring to the compiled code residing in the logic component table 14 and the individual data components residing in the data component table 16 without having to alter the underlying logic and data components, and without having to compile the higher-level software. In other words, the DRT 12 implements a vehicle for assembling the underlying logic components 14 and data components 16 into single and multi-record structures 20 for incorporating all types of data and implementing all types of software functions within the DRT 12. Specifically, the single and multi-record structures 20 generally include data records for incorporating data items into the DRT 12, execution records for incorporating software items into the DRT 12, condition records for specifying conditions for executing a corresponding execution record, and view records of different types for specifying elements to displayed in connection with a corresponding data item as well as other types and sub-types of records.

These single and multi-record structures 20, as well as individual logic components 14 and individual data components 16, may be used to create infrastructure modules 22. These infrastructure modules 22 implement reusable functionality that in most cases is not normally directly accessed by the user. The infrastructure modules 22 typically include a kernel for integrating the EXOBRAIN system with the operating system and other external hardware and software elements. The infrastructure modules 22 may also include a command matcher module that enables command output from either a meaning processor or the GUI 18, or both, to be matched to specific execution records. The infrastructure modules 22 may also include a GUI controller to connect the records of the DRT 12 with the GUI 18. The infrastructure modules 22 may also include a meaning processor for resolving language data into numbers concept language, using numbers concept language records stored in the DRT 12. This enables the EXOBRAIN system to receive commands in natural human language, translate them into correctly formatted DRT records containing the correct numbers concept language values, and output records that are ready to be matched by the command matcher to specific execution records or to records that kick off suitable executions records or logics when they are selected by the matching process.

Referring now to the interrelated operation of the infrastructures modules 22, when the EXOBRAIN system 10 first starts, the bootstrap logic, which instantiates and initializes the EXOBRAIN system, supplies the GUI controller with an initial view, which is used as a desktop but is otherwise a view like any other. In this particular embodiment, the GUI controller is not necessarily a single or multi record structure, but may be compiled code that accepts DRT records as input and outputs commands that drive the GUI 18, which is described in U.S. patent application Ser. No. 09/710,826 entitled “Graphical User Interface.” The GUI 18, in turn, interfaces with the keyboard, mouse, speakers and other input-output devices via the Java run-time structure that effectively interfaces between the Java class files and the underlying operating system. Equally, if Java is not being used, the equivalent functionality can be constructed in any other suitable programming language.

The desktop view typically contains buttons that enable the user to implement a sufficient menu of functionality to get the system started. Optionally or alternatively, the desktop may include a talk box into which commands can be entered for subsequent processing by the meaning processor. Although a visual input-output mechanism is used as an example in this specification, the same general principles are applicable to, and provide a foundation for, a non-visual input output system, such as text to speech combined with voice recognition (speech to text), although additional and obvious parts may be required to implement these capabilities.

The mechanisms for implementing a button are described below to illustrate the principles that are generally applicable to all active elements in the EXOBRAIN system 10. Briefly, “active elements” may be used to implement all of the elements displayed by a user interface, such as a button, a box, a sound, an executable instruction, etc. Any particular button is usually represented as an independent record of its own (button) type, which contains in its different fields all the appropriate parameters to specify the display and activities of that button. This record may be a list record that identifies other records, or it may specify the button's parameters in a vector referenced in the method field or in an alternative suitable field that is a standard part of every DRT record. Alternatively, otherwise unused fields on other records may be used to store the appropriate parameters to define a button in a standard manner for all buttons. In any case, the administration fields in the DRT 12 are used to designate particular record types, including the button record type and all other record types. In addition, administration fields designated as “Name” or “Given Name of This Item” and associated sub-type fields may be used in a standard manner to permit all button records to be located with a “find specification,” which sets forth a set of record characteristics that define a search request for records within the DRT 12 that correspond to the find specification. The general method for construction, saving and using a find specification is described in the U.S. patent application Ser. No. 09/712,581 entitled “Any-To-Any Component Computing System.”

Specifically, buttons records having certain parameters may be located by specifying their respective records using the “menu” field of the DRT 12, which can either contain a vector or (preferably) point to a list record containing the record list. Alternatively, button records having certain parameters may be located by running a find specification to locate buttons conforming to the specified parameters. Clicking a button causes the GUI controller to communicate this in the form of DRT records to underlying modules that fetch the button's DRT record and pass this record to the command matcher module, which then uses that record as a find specification to locate the appropriate execution record or records in the DRT 12 for that button. More specifically, the command matcher module uses the button's DRT record received indirectly from the GUI controller as a find specification, which the command matcher uses to locate the appropriate execution records in the DRT 12 for that button. The command matcher then supplies the button's execution records to the kernel, which causes the compiled code contained in or referenced by the found execution records to execute.

Active elements operate in a similar manner, which means that the GUI controller accepts user interface commands as inputs, and outputs DRT records, which may be immediately passed to the command matcher module or stored and made available for reload later. This process may also work in the other direction, in which the GUI controller receives DRT records and inputs, and outputs commands that drive the GUI 18. The properties of an active element include, but are not limited to, background shape, size, location, image and color; border type and width; system text font, size, text colors and styles; user entered text font, size, colors and styles; mouse actions for clicks, drag and other effects; etc. Because properties are constructed in a modular manner, new properties can be added on the fly without reconstruction and when added, become immediately available to all active elements.

In the collection of code referred to as the GUI controller, each property has two logics. One logic may be used to return the value of the property, and another logic may be used to change the value of the property. Collectively, these logics constitute the run-time interface that allows the code underlying the data-handling execution records to have full control over every aspect of any active element on the screen. Hence, the GUI and GUI controller do not themselves take any independent action, but simply respond to the orders received from any underlying modules in the form of DRT records on the one hand, and, on the other, outputs whatever the user does in the form of DRT records, which are then used by the code of underlying execution records. Hence, the screen is able to respond to the orders of any underlying modules, so long as they communicate in the standard manner using DRT records. Feeding suitably changing parameters to the GUI controller 20 run-time interface results in animation; as examples of this, feeding a continuously changing series of coordinates results in an active element moving across the screen; feeding different size coordinates in a loop makes the active element appear to pulse, and so forth.

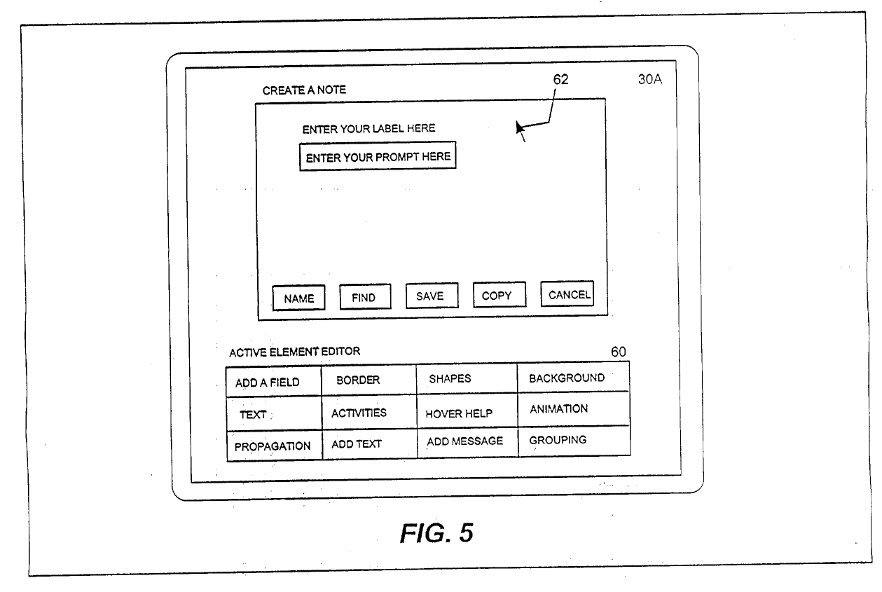

Hence, the active element editor 60 (shown on FIG. 5) is simply a view that calls certain logics to change property values through the run-time interface. Generally, the active element editor 60 has an active element for each property or group of properties. The appearance or construction of an active element editor as it appears on the screen is irrelevant to the underlying functionality because the view of the active element editor is just another view that can be customized like any other and in an ExoBrain, everything that appears on the screen is either a view, or a part of a view. Active elements can communicate with one another, also using the run-time interface. For example, an active element can be created to work directly on another active element, or it can be configured to find another active element at run-time by name. This particular mechanism is typically used in the case of the active element editor, in which buttons are used to call other appropriate other active elements to be displayed, which constitute what appears as a menu launched by that button. These infrastructure modules allow the user, through the GUI 18 and the DRT 12 to control the EXOBRAIN system 10, to access and control all types of data and execute all types of code contained in or referenced by the DRT 12.

The infrastructure modules 22 also include a number of reusable lower-level modules 20 or logics 14 that the higher-level applications may incorporate by reference or call on demand to include the associated functionality in the higher-level applications without having to create multiple instances of the lower-level reusable functional units. For example, these functions may include save elements, find elements, item maker elements, the modules and logics needed to create and use view templates, and other lower-level reusable components as determined by the EXOBRAIN system developers. These infrastructure modules 22, in turn, are available to be called by or referenced by higher-level reusable functional units 24, such as math functions, time functions, e-mail functions, fax functions, text functions, view functions, communication functions, send functions, chat functions, share functions, chart functions, share functions, browse functions, save functions, find functions, and other higher-level reusable components as determined by the EXOBRAIN system developers. The logic components 14, the structure and function for recording and using data components 16, and the infrastructure modules 22 are typically created and used by EXOBRAIN system developers to create the user-accessible reusable functional units 24. These user-accessible reusable functional units 24, along with the individual data components 16, the single and multi record structures 20, and some of the infrastructure modules 22 may be accessed by non-programmer designers and end users to create the EXOBRAIN equivalent of commercial grade applications 26 of all descriptions. Typically, the logic components 14 are not made directly available for end users or program designers to access in the construction and manipulation of the higher-level applications 26. That is, professional program designers and end users are typically permitted access to the reusable functional units 24, the data components 16, the single and multi record structures 20, and some of the infrastructure modules 22, which they use to construct customized applications 26 of their own design.

Further, the higher-level reusable functional units 24 are typically designed so that they may be made generally available to users of all descriptions. Nevertheless, for commercial reasons depending on the target customers of a particular EXOBRAIN system or product, access to the reusable functional units 24 may be limited to professional designers who create the EXOBRAIN system equivalent of higher-level commercial grade applications 26, which in turn may be directly accessed by end users. These commercial grade applications 26 typically include at least a calculator application, a calendar application, an e-mail application, a fax application, a word processing application, a spreadsheet application, a database application, an application for sending data between host systems, an application for implementing chat between host systems, an application for sharing data among host systems, a charting application, a browser application, a remote save application, navigation applications, and other higher-level customized applications as determined by the EXOBRAIN system developers. However, the tool set made available to designers and end users alike is designed to allow all users to customize pre-configured application and create new applications from scratch. That is, end users and EXOBRAIN application designers may further customize and adapt the customized applications 26 to create highly configured applications and special use programs 28 for a virtually unlimited range of applications, or alternatively, may create such highly adapted applications from scratch using the reusable functional units 24, the data components, or component data structures and functions, or both, 16, the single and multi record structures 20, and the infrastructure modules 22. In addition, the end user-functionality 26, 28 of each user's EXOBRAIN system may be both created and modified by and for that particular user or use “on the fly” without having to recompile the underlying code.

Because the compiled software components are incorporated by reference into the DRT 12, and may optionally also be stored in it, the individual compiled components can be incorporated into many different software assemblies without having to maintain multiple instances of the compiled components and without having to write multiple instances of code that is similar in function, and essentially similar in construction but adapted for a different application. This reduces the size of the compiled code for sophisticated software by factors of hundreds or thousands and also reduces the number of sources, and hence the complexity and effort required to detect and correct “bugs” due to the absence of multiple very similar (but not identical) blocks of code performing essentially the same function but in different “applications.” In addition, new software may be written, and existing software may be altered “on the fly,” without having to interrupt the user sessions to recompile the underlying code. Further, pre-configured labels and other text items may be changed “on the fly” without having to interrupt the user sessions to recompile the underlying code and a further result is that any user can easily create and store multiple views for data items “on the fly” during an uninterrupted user session.

The practice of recording all of the parameters specifying a view as records stored in the DRT database 12 enables the views to be transmitted to other EXOBRAIN systems in a very compact form that transmits quickly, and in such a manner that they can be processed appropriately by the recipient EXOBRAIN system on arrival. This allows each user to exchange views with other users using e-mail, file sharing, electronic chat and other available mechanisms for exchanging electronic data. Because the views are implemented within the EXOBRAIN infrastructure, complex views including images, animations, sound, and executable activities may be transmitted from one EXOBRAIN system to another, and the views run properly when received during an uninterrupted user session. In some instances, a view may utilize a logic component that is not included in the receiving party's set of compiled logic components 14, or a data component that is not included in the receiving party's set of data components 16. In this case, the receiving EXOBRAIN system can be set up to recognize this condition and to request a download of the missing component from the transmitting EXOBRAIN system or from elsewhere. This process, which can occur automatically during the on-going user session, seamlessly updates the receiving party's. EXOBRAIN system. As a result, the received view can function properly when received or moments later.

The EXOBRAIN system described above represents a fundamentally new paradigm for software construction that solves the systemic problems encountered with conventional methods for assembling software. Many highly useful and previously unattainable software features and features only attainable with much greater difficulty of construction and use and cost and time can be implemented in this type of programming environment with greatly reduced construction time and difficulty, greatly reduced storage requirements, and greatly simplified maintenance and upgrading regimes as well as with greater simplicity for the user and greater transparency of the underlying mechanics for the user as well as overall power, as users can now construct their own applications without programmer assistance. In particular, the dynamic item manipulator described below is one example of such a feature that becomes easier to enable in this environment. The dynamic item manipulator allows multiple users to each create and save multiple views for data items to be rendered by the EXOBRAIN system. These user-defined views can be created, saved and subsequently accessed “on the fly” during an uninterrupted user session without having to recompile any code or restart an application or file. As a result, every user can easily create customized views for himself or others to implement a wide range of functions, such as screen text in different languages, creation of training platforms, displaying helpful items in a user's own words, customized data views for special purposes, customized data views for other persons, and so forth.

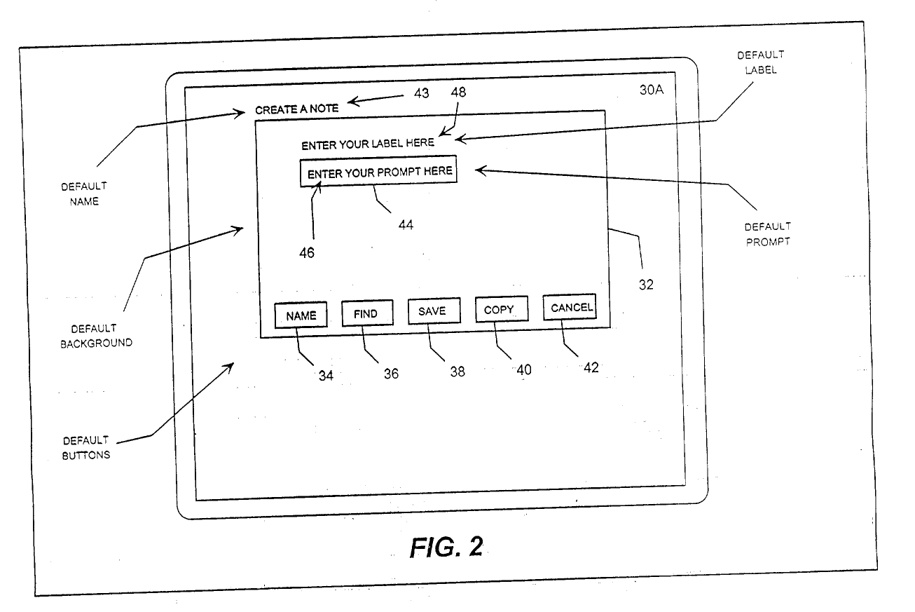

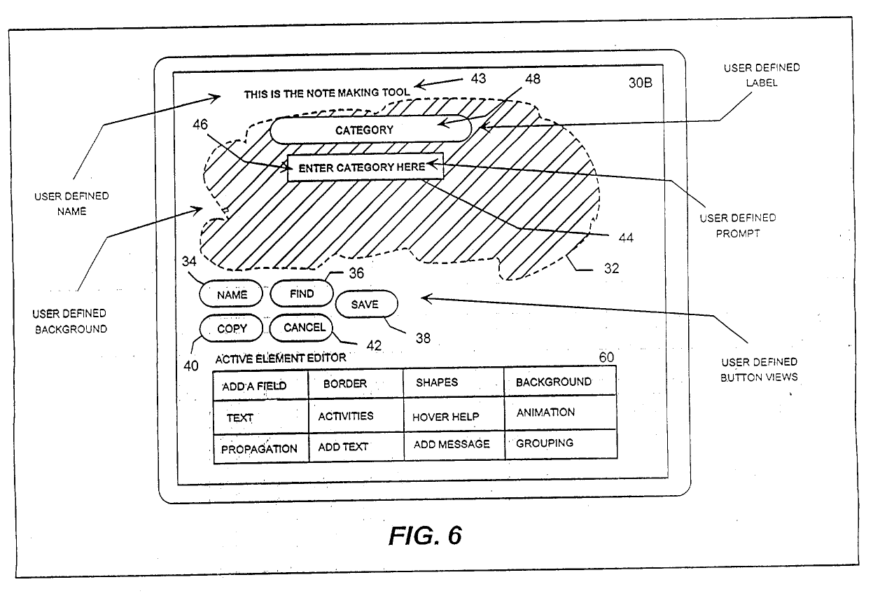

FIG. 2 is a user interface display illustrating a pre-configured note view 30A for displaying a data item. For illustration purposes, the dynamic item manipulator will be described with reference to this simple item for creating a note. It should be appreciated, however, that the basic functionality described with reference to the note view 30A may be implemented for any view, or any data item, or any combination of data items. Additionally, while this description is given in relation to a view of a single item at a time, it will be appreciated that the exact same principles and methods apply to list or tabular views of many items simultaneously and that the term ‘view’ applies equally to a view of a single item, or a simultaneous view of many items. In addition, for the purposes of this particular example, the “pre-configured” note view 30A may be created in any manner prior to the current user session, in which the user-defined changes described with reference to FIG. 6 are entered. In particular, the pre-configured note view 30A may be created by a programmer and embedded in compiled code, or it may be created a non-programmer designer, or it may be created by a user using the tools of the EXOBRAIN system. However, given the functionality of the EXOBRAIN system, it should be understood that defining the note view 30A in complied programming is not the recommended approach. Nevertheless, this situation might occur when adapting a view defined in a legacy application to an EXOBRAIN system, but that discussion is beyond the scope of this specification. In any event, for the purpose of the present description, the note view 30A is, in one manner or another, saved prior to the user session during which the user-defined view 30B is created. This is the characteristic that makes it a “pre-configured” view, as defined previously.

The note view 30A illustrated in FIG. 2 includes a background element 32, in this instance a rectangle having a shape, border, background, color and other definitional parameters. The note view 30A also includes five buttons, including a name button 34 for creating new named views, a find button 36, a save button 38, a copy button 40, and a cancel button 42. Each button implements the corresponding activity indicated by the button's label. The note view 30A also includes a message element 43 stating “create a note” and a field element 44, which is rectangular text box having a shape, border, background, color and other definitional parameters. Continuing with description of the field element 44, a text prompt 46 appears within the text box stating, “enter your prompt here”; and a text label 48 appears adjacent to the text box stating, “enter your label here.”

Basically, any view, such as the note view 30A, allows the user to replace the text prompt 46 with a user-defined prompt, such as a new text string or a link to a data element that the user would like to appear in association with the field element 44 in any location that the user may desire. The user may also replace the pre-configured label 46 with a user-defined label, and so forth. In fact, all of the characteristics of the note view 30A, like all views constructed in the EXOBRAIN system, may be redefined by the user in the manner described herein or, for that matter, in another manner that may be created in DRT format with the tools of the EXOBRAIN system. To illustrate this principle, consider the field element 44, which is a “field active element” that allows the user to display within the field element 44 of the note view 30A any data item contained in a field of a DRT format, whether contained in the user's EXOBRAIN system or that of another. The field element 44 may also be used to enter a user-supplied data item into a field of a DRT of user's EXOBRAIN system. That is, a “field active element” is a two-way user interface element that can be used to display any data component contained in a field of a DRT record, or to enter data into a field of a DRT record. Typically, the user creates a new field item by selecting a suitable field in the DRT from a list of available fields. Doing so causes the field active element 44 to initially appear on the user interface with certain default characteristics, such as those illustrated for the field active element 44 in FIG. 2. These default characteristic, like all properties of all active elements, may then be redefined by the user using the tools of the EXOBRAIN system.

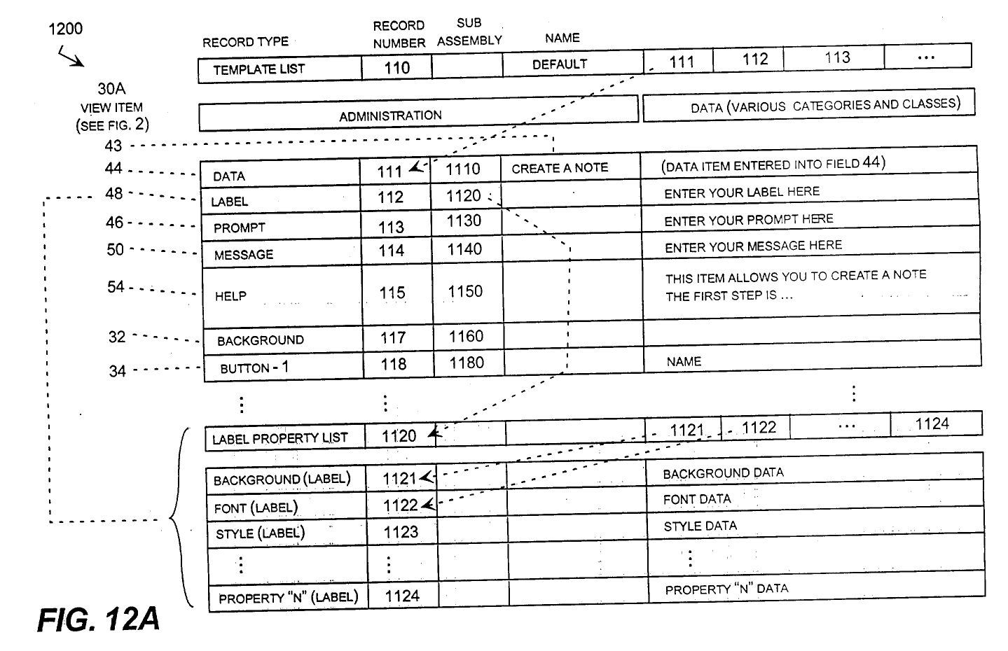

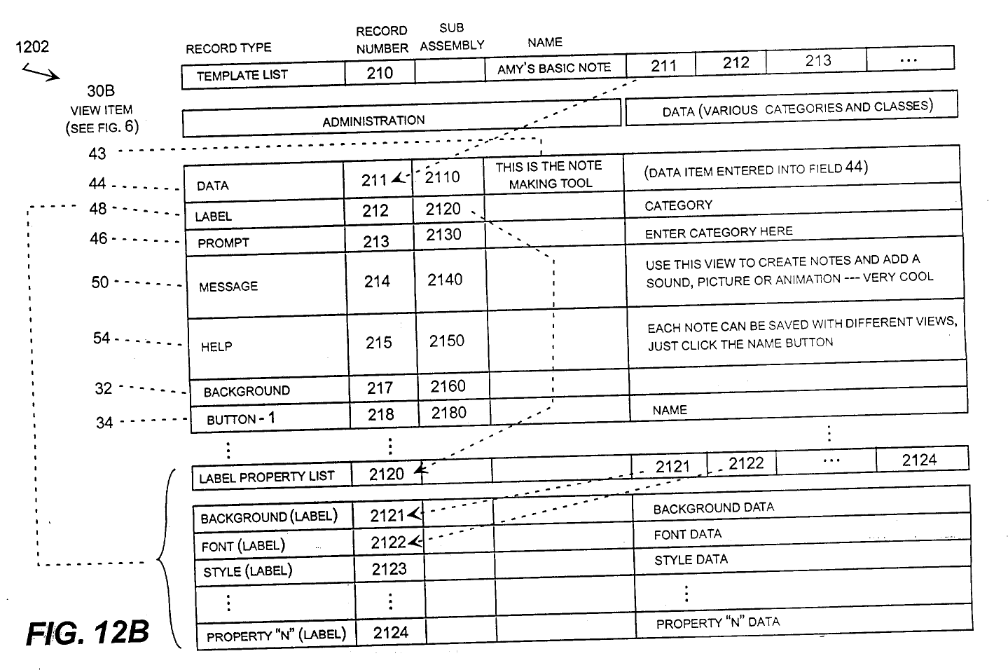

In general, the user can add multiple fields, buttons, list boxes and other control items to any view, and may add a wide variety of effects to any view or any active element within a view, up to and beyond adding the full panoply of functionality (in the form of buttons and menus) that would be found in a spreadsheet or word processing program, or another program, as examples such that the end results would be said by the user to be a word processor, for example. This may be accomplished using EXOBRAIN system tools, such as the active element editor 60, which is described below with reference to FIG. 5, and other user tools that may be created by programmers using EXOBRAIN system and other tools. It will be understood, therefore, that the active element editor 60 is not a static item, because it is itself composed of re-definable active elements. Further, the active element editor 60 is not the only tool that can be used to manipulate views and associated DRT records. For this reason, all of the discrete units of a view are termed “active elements” because each can be “active” in that it may be appear to be configured to perform or display effects, such as text, images, animation, sound or executable activities when the view or active element is selected, or in accordance with some other condition or protocol defined by the user, but when doing so in an EXOBRAIN the preferred method is the actual effect is implemented by associating the same field of different underlying effects modules with the field concerned; while the user is given the impression, and thinks of the effect as a characteristic of the active element itself. Active elements may also be associated with properties defining the active element and other active elements in a “nested” manner created by a nested record structure defined within the DRT, as described in more detail with reference to FIG. 12A below. Continuing with the example illustrated by FIG. 2, items 32, 34, 36, 38, 40, 42, 43, 44, 46, and 48 may all be considered to be “active elements” associated with the note view 30A and in that sense, a view is a particular collection of active elements. In view of this high level of functionality that may accompany a view or an active element within a view, it will be appreciated that the specific pre-configured note view 30A shown in FIG. 2 is intended to serve only as a very simple illustrative example.

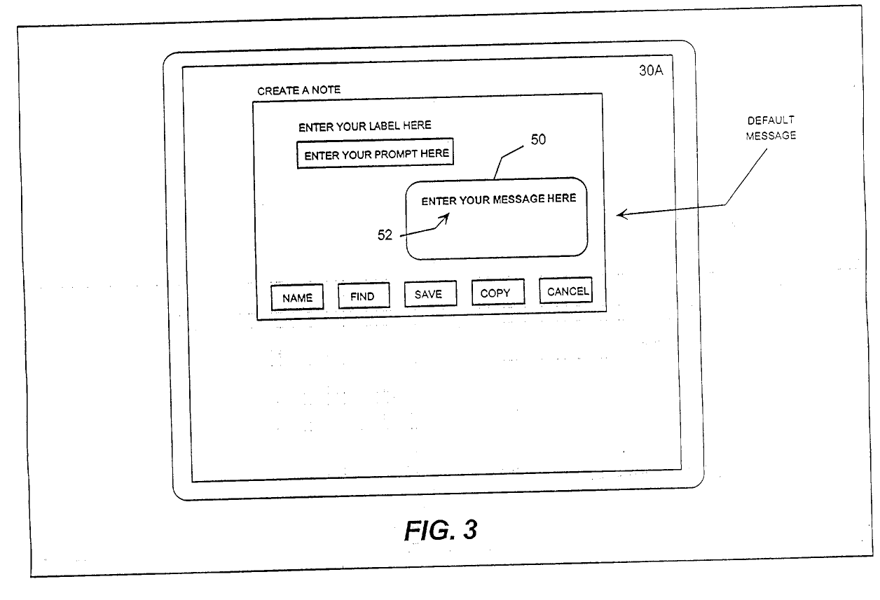

FIG. 3 illustrates a previously added message field 50 that may be made part of the note view 30A using the active element editor 60 so that it automatically appears whenever the note view 30A is accessed, or in accordance with another protocol defined by the user that can be added, removed or changed using the active element editor. The message field 50 includes an element, in this instance a rectangle, having a shape, border, background, color and other definitional parameters. The message 50 also includes a text string 52 stating, “enter your message here.” The user, when using the note view 30A to create a particular view, or at any time, may replace the pre-configured text string 52 with an appropriate text message for that note alone or for all notes.

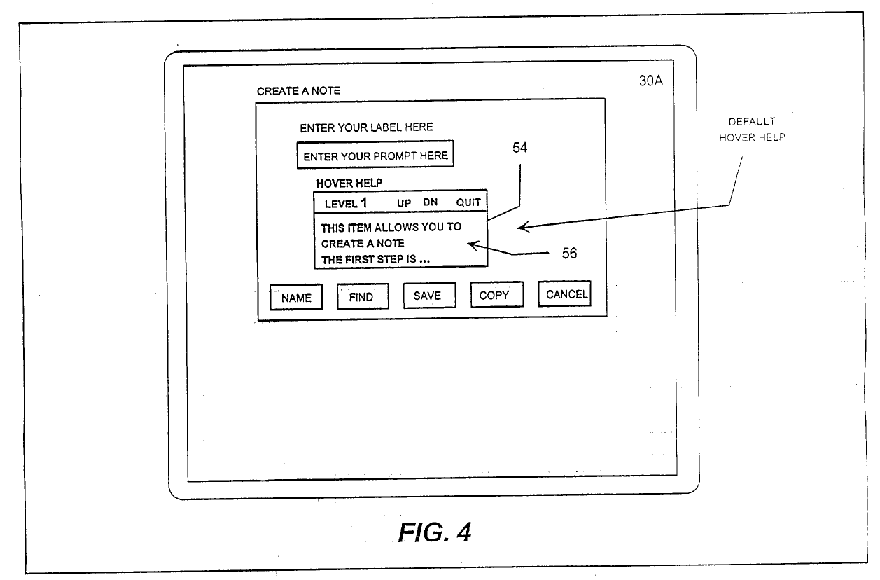

FIG. 4 is a pop-up help item 54 associated with the note view 30A. Such a pop-up help item may be turned on or off in relation to any active element using the active element editor 60 and, since it is associated with a particular active element, may contain text and other effects appropriate to the particular active element with which it is associated. Typically, help items such as this are implemented as “hover help” items that can be configured by the user to pop up when the user pauses the cursor over any particular discrete visual item. The help item 54 is itself a configurable view that includes a functional user interface for scrolling amongst a hierarchical set of levels of help. Some of these levels may have default entries pre-configured by a non-programmer functionality designer, using the mechanisms described previously, whereas others may be left for users to fill in on an as-needed basis. The help item 54 also includes an element, in this instance a rectangle, having a shape, border, background, color and other definitional parameters. The help item 54, which is shown operating in “Level 1,” includes a text string 56 stating, “this item allows you to create a note the first step is . . . ” The user, when using the note view 30A to create a particular note, may replace the pre-configured text string 56 with a user-defined help message, and may also enter help messages for other levels of help, which are accessible by the help item 54. Although there is no conceptual limit to the number of levels of help that can be added to a help item, three to seven levels of help are presently considered appropriate as a design standard for general applications.

Typically, the user may add a wide variety of functionality and effects to any or all of the screen items, which are added by choosing from a list of available buttons representing different functionalities that can be added or removed to the view using the active element editor 60, which is shown on FIG. 5. Examples of such functionality that has been added to the view shown in FIG. 2 are the name button 34, the find button 36, the save button 38, the copy button 40, and the cancel button 42. Additionally, and again using the active element editor 60, other effects may be added or removed by the designer or the user to the buttons and the non-button active elements, such as the field element 44, the text prompt 46, the label 48, (and, referring to FIG. 3) the message 50, and (referring to FIG. 4) the help item 54. In particular, any of these items may be modified to include or activate a sound, an image, an animation, or an activity to be implemented automatically upon activation of the note view 30A, or upon selection of the particular active element, or in accordance with some other protocol defined by the user.

For example, such an activity may include a look-up and display activity, a link and display activity, a compute and display activity, or any other type of activity defined by the user and again, these effects may be added, removed or changed using the active element editor 60. To assist in creating this high level of functionality, the selection of an item on the active element editor 60 may lead to further screens and user interface tools for creating and selecting effects to associate with views and active elements contained within views. For example, these tools may allow the user to select images from an image library, create new images, and search for images on a network; select sounds from a sound library, record or create new sounds, and search for sounds on a network; select animations from an animations library, create new animations, and search for animations on a network; select executable activities from an activities library, create new activities through “follow me” or other techniques, and search for executable activities on a network. Both data, such as numerical and text strings, and software, such as animation and executable activities, may be associated with an active element in this manner.

FIG. 5 illustrates an active element editor 60 for altering any view, such as the note view 30A in this example. The active element editor 60 is typically activated by placing the cursor 62 on or near an active element to be modified and right-clicking the mouse. However, any suitable type of activation mechanism may be used, such as a menu selection, key selection, and so forth. The active element editor 60 includes a number of buttons for manipulating active elements, such as those comprising the note view 30A. Each button may include sub-features, such as a pop-up menu or pallet. Those skilled in the art will appreciate that the active element editor 60 shown in FIG. 5 is a simple illustration of the type of features that may be implemented in an editor of this sort, and that many other features for the active element editor 60 may be created and implemented by programmers and users. Note that, as implemented in an EXOBRAIN system, the active element editor can itself be a view that can itself be configured by the user as described herein, by using the active element editor itself to do so.

FIG. 6 is a user interface display illustrating the note view 30B, which corresponds the note view 30A after a few user-defined changes imparted on the view using the active element editor 60. For example, the background 32 has been changed to a cloud shape with a hatched interior. The buttons 34, 36, 38, 40, and 42 have been changed to ovals and relocated. The message element 43 has been changed to include a user-defined message stating, “this is the note making tool.” The prompt element 46 of the data entry/display field 44 has been changed to include a user-defined prompt stating, “enter category here.” The label element 48 has had its border turned on and an oval shape selected for it and its text changed has been changed to a user-defined label stating “category.” Using the techniques described previously, many other active elements may be added to the view 30B, and many other effects may be added to the view and the active elements within the view. For example, an “e-mail” button may be added to the view 30B, which activates an activity in which the view 30B and the particular data record it is showing is e-mailed to another system. Continuing with the example, all of the visible text may be translated into a foreign language and this new view may be saved under a new view name. This new view may be e-mailed to another system using the “e-mail” button contained within the view. Importantly, the same instance of the compiled code underlying the “e-mail” button may be reused for many views because, in any EXOBRAIN system, that functionality may be constructed from complied components located in the table of logic components 14 shown in FIG. 1. As noted in the description of FIG. 1, this is a generally-applicable feature of the “component processing system” enabled by the EXOBRAIN system 10.

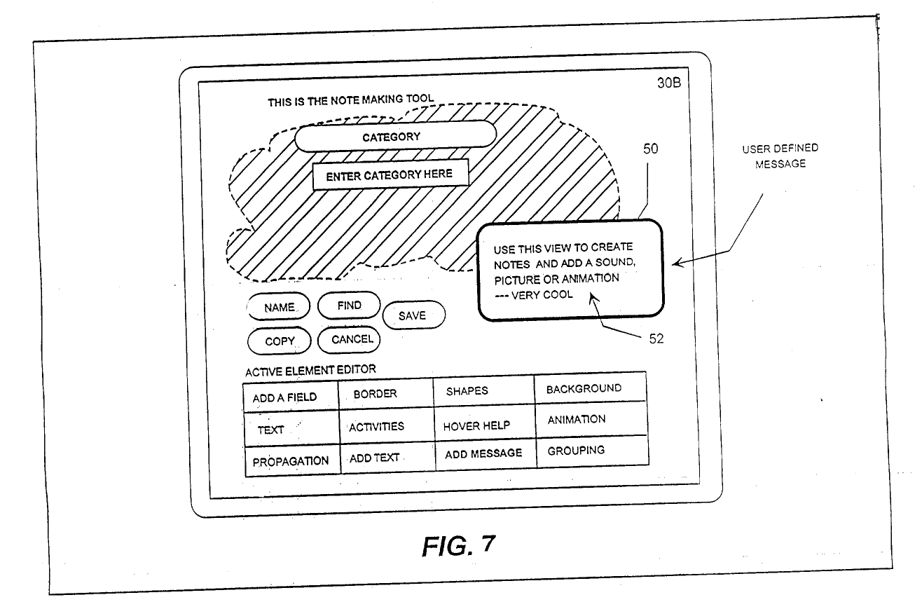

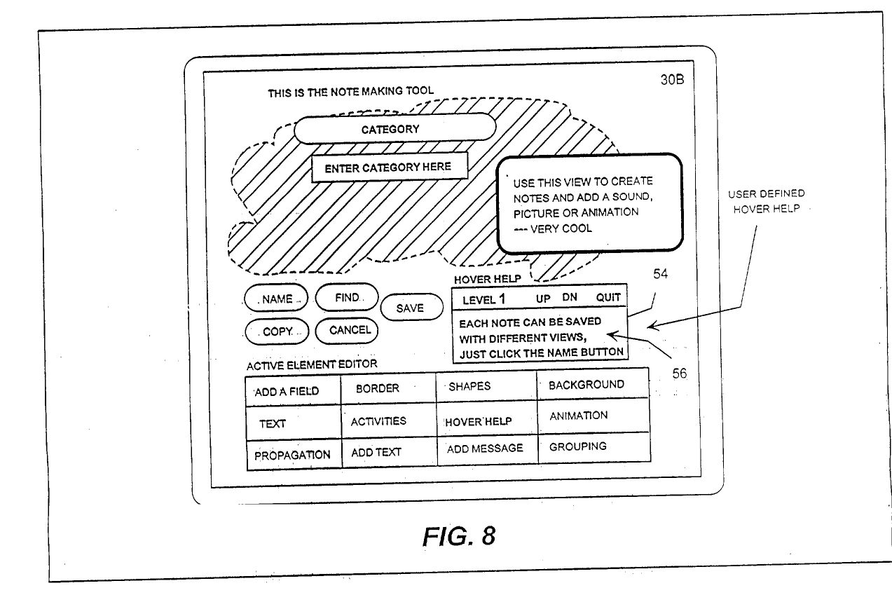

FIG. 7 shows that the active element 50 has been changed to include a user-defined text string stating, “Use this to view to create notes and add a sound, picture or animation—very cool.” Note that this message active element 50 does not have a label displayed in relation to it. FIG. 8 shows that the help item 54 has been changed to include a user-defined text string stating, “each note can be saved with different named views, just click the name button.” Of course, the preceding example is provided as an illustrative set of changes, and each user may enter different user-defined elements to create multiple views for any data item.

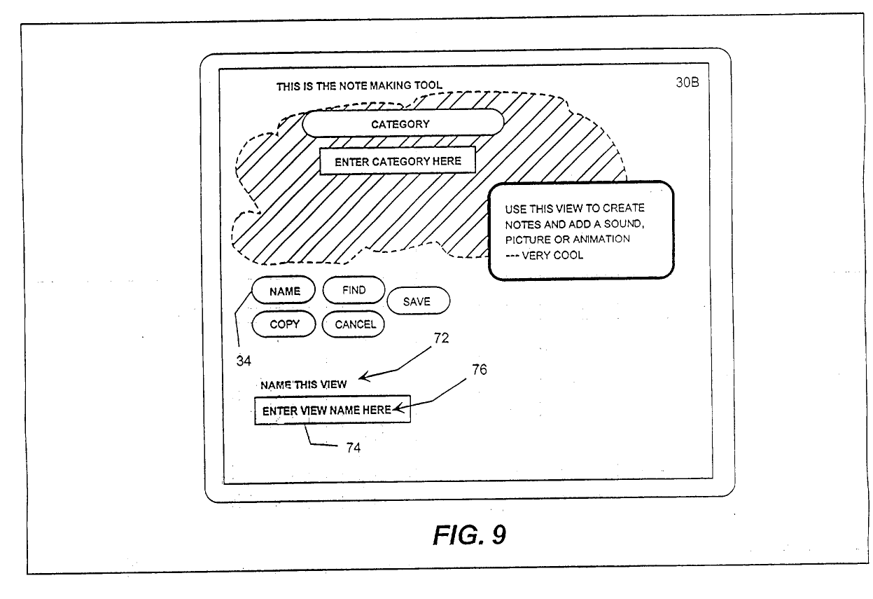

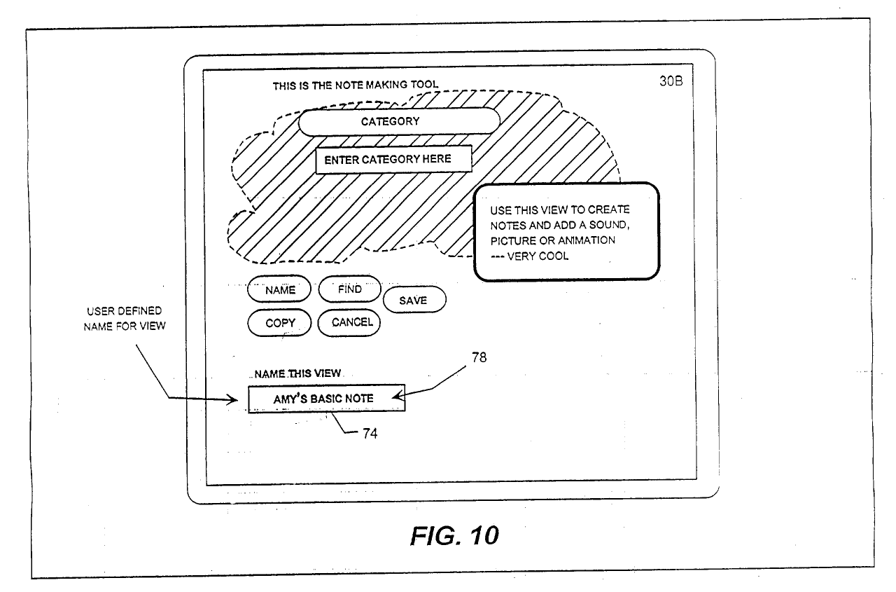

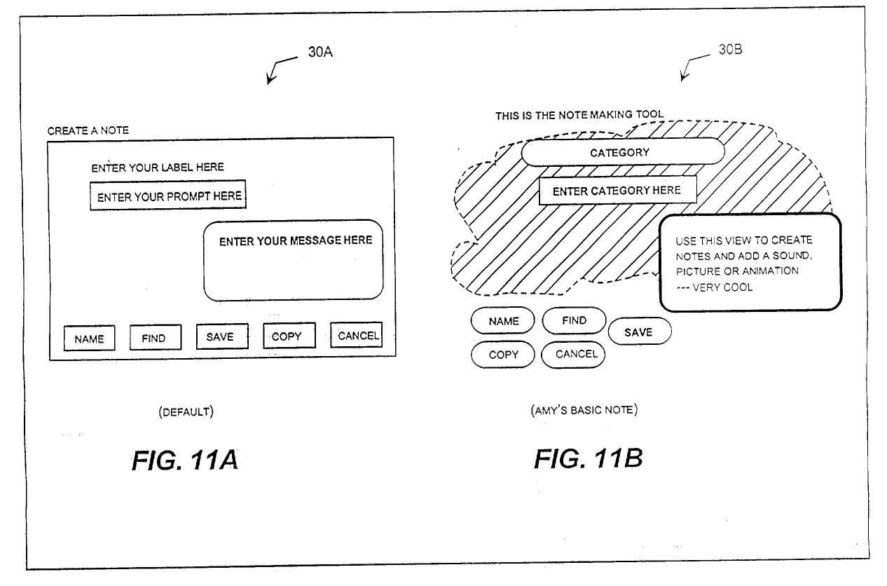

FIG. 9 illustrates a “view name” utility 70 that typically pops-up upon selection of the “name” button 34. This utility includes a message 72 stating “name this view” displayed adjacent to a text box 74 displaying a prompt 76 stating “enter view name here.” Alternatively, instead of displaying the prompt 76, the existing name of the current view may be displayed so that the user knows what it is. Since this view name utility is itself a view in the standard manner, the user may change the active elements that it displays in any manner made available, for example by use of the active element editor 60. FIG. 10 illustrates the entry of a user-defined view name 78 for this particular view, namely “Amy's basic note,” which the user has typed over to replace the previously displayed text “enter view name here” appearing in the text box 74, and by so doing, creates a new view with the name “Amy's basic note.” The previous view still exists, however, under its name, “default view.” In particular, FIG. 11A shows the default view of the view note 30A, which contains the pre-configured items for this view. These pre-configured items are in some instances referred to as the “default name,” “default prompt,” and so forth for descriptive convenience. FIG. 11B shows the user-defined view 30B, which is the user-defined view named “Amy's basic note.” This view includes the user-defined label, prompt, message, etc. Note that the various active elements included as part of the views are not necessarily constrained to be within a “window” as the term is commonly used, but may be placed anywhere, including off the visible desktop.

FIG. 12A is a block diagram illustrating a DRT data structure 1200 for storing definition information for the default view of the view note 30A. Specifically, the default view of the view note 30A is typically represented in DRT format by a template list record 110, which is a top-level list record that incorporates a list of other records that further define the view note. This particular list record is termed a “template list record” for purposes of descriptive convenience. The name of the view, “default,” appears in the “name” field within the administration category of the template list record 110. Placing the entry “default” in the “name” field allows a find specification to be created to locate this record by searching for items with the name “default.” A find specification is an EXOBRAIN infrastructure-level function that typically operates in association with administrative fields, such as the “name” administration field, as described in more detail with reference to FIG. 1. The record 110 also includes a list of additional records that further define the view 30A, typically within consecutive fields within the data section of the DRT record. In this example, the list includes record numbers 111, 112, 113, etc., which all identify other DRT records that further define the view. These records are usually organized in a field parallel structure, which is also described in more detail with reference to FIG. 1.

Referring to FIG. 2 to further illustrate the record 110, the first item in the list references record 111, which corresponds to the field element 44; the second item in the list references record 112, which corresponds to the label element 48; the third item in the list references record 113, which corresponds to the prompt element 46; the fourth item in the list references record 114, which corresponds to the message element 50 of FIG. 3; the fifth item in the list references record 115, which corresponds to the help element 54 of FIG. 4; the sixth item in the list references record 117, which corresponds to the background element 32; the seventh item in the list references record 118, which corresponds to the “name” button element 34; and so forth. The list record 110 may reference as many records as necessary to fully define the note view 30A. However, every attribute of the view does not need to be directly included in the top-level list record 110 because each record in the top-level list may, in turn, identify a sub-assembly including a list record further defining the referenced record. The sub-assembly list record may, in turn, identify its own sub-assembly record, which may includes another list record. This process may be repeated as many times as necessary to create a nested set of DRT records defining every aspect of the view 30A, including every visible element and every other effect associated with the view.

To briefly illustrate this practice, the list record 110 incorporates the data record 111, which incorporates the sub-assembly record 1110, which may incorporate another list of records, each incorporating further records. Similarly, the list record 110 incorporates the label record 112, which identifies the sub-assembly record 1120. For this particular record, FIG. 12A shows a simple example of a sub-assembly structure. Specifically, the sub-assembly record 1120 is a label property list record, which incorporates records 1121, 1122, 1123, 1124, and so forth, which further define the appearance of the label 48. For example, record 1121 specifies the background for the label; record 1122 specifies the font for the label; record 1123 specifies the style for the label; and so forth up to record 1124, which is identified as the property “n” record for the label to indicate that any number of property records may be included in the list to fully define the label. Each of these records could, in turn, incorporate additional nest records to further define the appearance and behavior of the active element identified as the label 48. In this manner, every active element implemented within the EXOBRAIN system 10, such as the view note 30A, may be defined by a series of nested DRT records that are all ultimately tied to each other. The tying element for the example involving view note 30A is the nested record path emanating from the top-level template list record 110. However, other types of tying elements may be implemented. Note that, although the illustrations only show a limited number of fields, each field of the property records 1121-1124 contains the appropriate values for the display of its own field on a field-parallel basis as further described in relation to FIG. 1.

To provide a few brief examples, items defined by records in this manner might simply specify a text style and color, or they might add an effect or a combination of effects to the element, such as an image, sound, animation or executable activity. For example, FIG. 12A illustrates the incorporation of text items into the view note 30A using this technique. Specifically, the label record 112 includes text string “enter your label here”; the prompt record 113 includes text string “enter your prompt here“; the message record 114 includes text string “enter your message here”; and so forth. In this manner, all of the visible text elements of view note 30A may be specified in the form of DRT records. The substantive data items, in this example the text strings, may be directly included in their associated DRT records as shown in FIG. 12A. Alternatively, the substantive data items may be composed of reusable data components that are incorporated into the DRT structure by reference to another location containing the substantive data item or a pointer that ultimately leads to the substantive data item. In particular, the DRT record structure may ultimately incorporate the substantive data items through reference to the reusable data components 16 shown on FIG. 1. Software may be similarly incorporated by reference to the reusable logic components 14, which are also shown on FIG. 1.

The question of whether to incorporate a particular data or software item directly or by reference to components is usually a design choice. Certain types of items, such as images of nature, are not well suited to component construction because they are inherently one-of-a-kind. Virtually all software, on the other hand, is constructed from reusable components that are useful in constructing other types of software. For this reason, software should, in most instances, be incorporated into the DRT structure through the component system to the extent practicable. The line of demarcation with respect to other types of items is not so clear, which will typically results in design choices. For example, certain applications may justify the extraordinary effort required to represent high resolution images of nature in component format, such as motion picture colorizing or human face recognition for security purposes. Other applications, such as e-mailing pictures of the new pet to friends, will not justify this type of expense. It should nevertheless be appreciated that the EXOBRAIN system may be used to store virtually any type of data, whether represented by components or not, and to relate any type of data to any other type of data through the DRT record structure.

FIG. 12A also illustrates that one of the visible items, the text string “create a note,” appears in the “name” field of the data record 111. In this case, this particular element also serves as a search parameter that may be used to locate this particular view 30A or any element associated with the view. For example, a find specification may be defined to locate a view having the name “default,” which in this example will return the record 110 which effectively locates all of the DRT records associated with the view note 30A. Alternatively, a find specification may be defined to locate a “data item” having the name “create a note,” which in this example will return the record 111. This record, in turn, identifies the data item 44. The record nesting path for this item may then be tracked forward to locate the template record 110, which locates the other records defining the data item 44, including all visible aspects and effects, including for example, animations, administration items, executable activities, and so forth. In this manner, any assembly of DRT records may be given a name for use in locating that particular assembly in particular, and more generally, for locating a group of similarly named assemblies (i.e., assemblies of the named type) within the DRT structure.

FIG. 12B is a block diagram illustrating a DRT data structure 1202 for storing definition information for the user-created view of the view note 30B. The data structure 1202 is usually similar to the default data structure 1200 except that the user-defined changes have been incorporated into the data structure 1202. In particular, the DRT structure 1202 typically starts out as a copy of the DRT structure 1200, which is then changed in response to user-defined changed to the corresponding view. For example, the DRT structure 1202 may be increased or decreased to reflect the addition or deletion of active elements, effects and properties contained view note 30B as compared to the view note 30A. In the example illustrated in FIG. 12B, the label record 212 includes the user-defined text string “category”; the prompt record 213 includes the user-defined text string “enter category here”; the message record 214 includes the user-defined text string “use this view to create notes and ass a sound, picture or animation—very cool”; the help record 215 includes the user-defined text string “each note can be saved with different views, just click the name button”; and so forth. Referring to FIG. 1, all of these changes are incorporated into the data structure of the DRT 12 without having to recompile the underlying logic components 14, reboot the host computer, or restart any application or data file. Thus, the changes required to create, save and access the user-defined view 30B may be accomplished “on the fly” during an uninterrupted user session. This is possible because all that is required to cause one displayed view to be changed to another displayed view, is for an underlying module to select the appropriate DRT records to be executed based on appropriate factors such as who the user is, or based on the user clicking a button to change from one view to another. More specifically, and with reference to FIG. 1, the infrastructure-level EXOBRAIN elements 22 use these factors to create one or more find specifications to locate the appropriate DRT records. The kernel then “feeds” the appropriate DRT records to the GUI 18 via the GUI controller, which converts the data and executable instructions received in the form of DRT records into data and executable instructions in the format expected for the particular screen which the GUI 18 is to display. This causes the screen to display the corresponding visible items in the usual manner. That is, the screen itself and any associated screen driver may continue to operate in the same pre-configured manner that it does with any other host system. In a similar manner, the EXOBRAIN system may interface with drivers for all types of peripheral devices in the usual manner, without having to replace or upgrade the peripheral devices to be “EXOBRIAN compatible” devices.

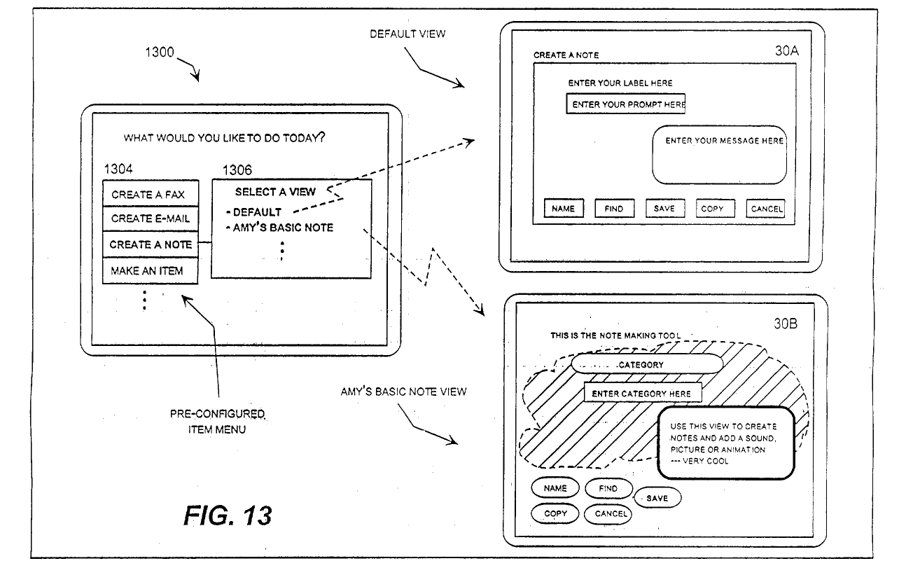

To permit view selection, FIG. 13 illustrates a user interface display showing an example of a view selection utility 1300 for selecting among a number of views for displaying a data item. In this particular example, a pre-configured item menu 1304 includes a selection item corresponding to the “create a note” item. Upon selection of this item, a “select a view” pop-up menu 1306 appears, which includes a list of available views for the “create a note” item. In particular, the “select a view” menu 1306 includes a first selection item corresponding to the “default” view 30A, and a second selection item corresponding to the “Amy's basic note” view 30B. Selecting the first selection item causes the host system to render the “default” view 30A, whereas selecting the second selection item causes the host system to render the “Amy's basic note” view 30B. In addition, the user may create and save additional views, which will then be available for access through the “select a view” menu 1306.

The “select a view” menu 1306 may be customized to initially appear with a selected view item corresponding to the view most recently accessed by the user. Alternatively, the “select a view” menu 1306 may be customized to initially appear with a selected view item corresponding to a view identified by the user as a preferred initial view. Alternatively, a “switch views” button may be placed on a particular view and when pressed, this button initiates an activity that opens a view such as the “select a view” menu 1306. In addition, the “select a view” menu 1306 is a view like any other view and, as such, is configurable like any other view. For example, it may be changed using the active element editor 60 so that it initially displays the last view accessed by the user, or so that it initially displays a view specified by the user as a desired initial view, or in other configuration that the user desires. Further, the view 30B may itself be optionally configured so that, when changes are made to the view, it initially comes up in whatever form it was in when the user exited from the view. In this case, changes to the view may automatically saved when the user exits the view, or the changes may not be automatically saved. In this case the user may be prompted to save the changes before a command that would result in exiting the view is executed. Equally, a module can be provided that is accessible from the Active element editor 60 to enable the user to chose the manner in which he wants the view to behave. Further, the appearance and functionality of the view selection utility 1300 may be defined and changed by the user just like any other active element, or combination of active elements, using the active element editor and the other techniques described in this specification.

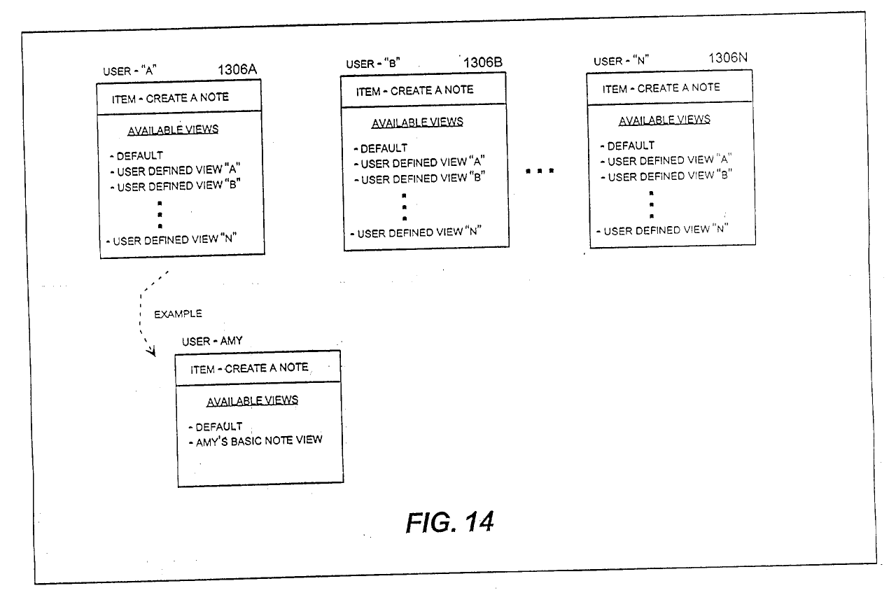

FIG. 14 illustrates several examples of typical view selection utilities, in this case several “select a view” menus 1306A-N, which allow multiple users to select among multiple views for displaying a data item. That is, each user may create, save and access his or her own set of views. In addition, each user may add more and different selections of complicated effects to views, such as sounds, animations, images and executable activities. In addition, each user may exchange views with other users using e-mail, file sharing, electronic chat and other available mechanisms for exchanging electronic data.

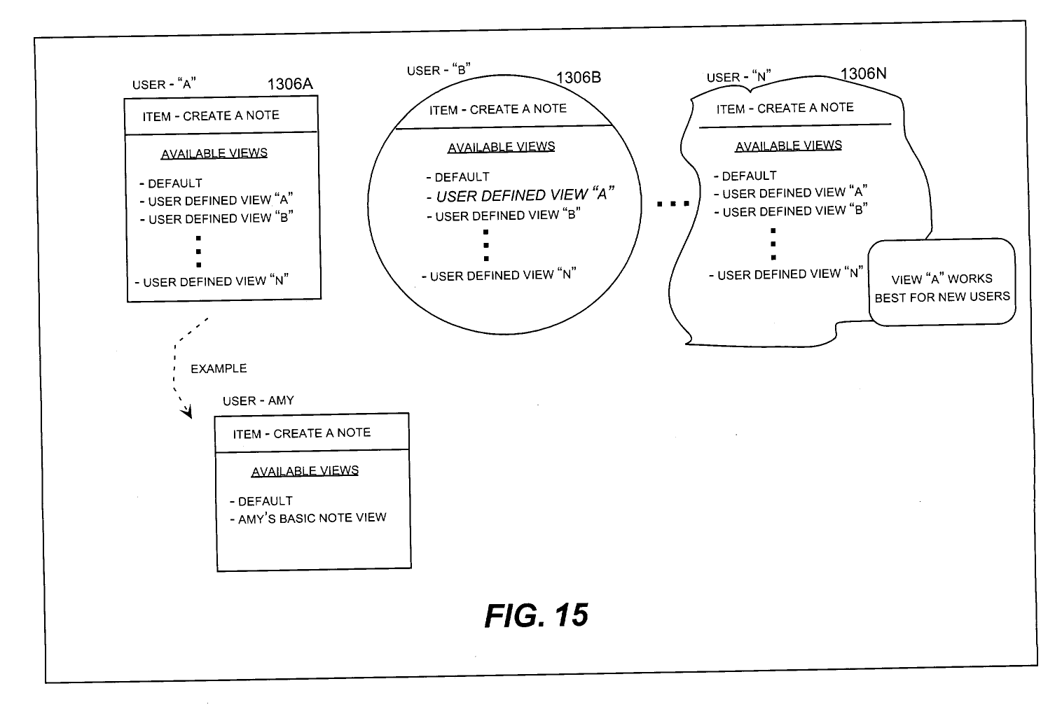

FIG. 15 shows several user-defined view selection utilities having different visual attributes selected by the corresponding users. This figure illustrates that the user-defined view selection utilities 1306A-N may be customized by each user to have different attributes, which may be defined using the same tools described above for user-defined views. Indeed, any view for any item may be customized by the user through the techniques described in this specification. Although only visible differences are illustrated in FIG. 6 for convenience, it will be understood that the view selection utilities may include other types of user-defined attributes that vary from utility to utility, including a wide range of effects such as multi-media effects, executable activities, administrative control functions, and other effects.

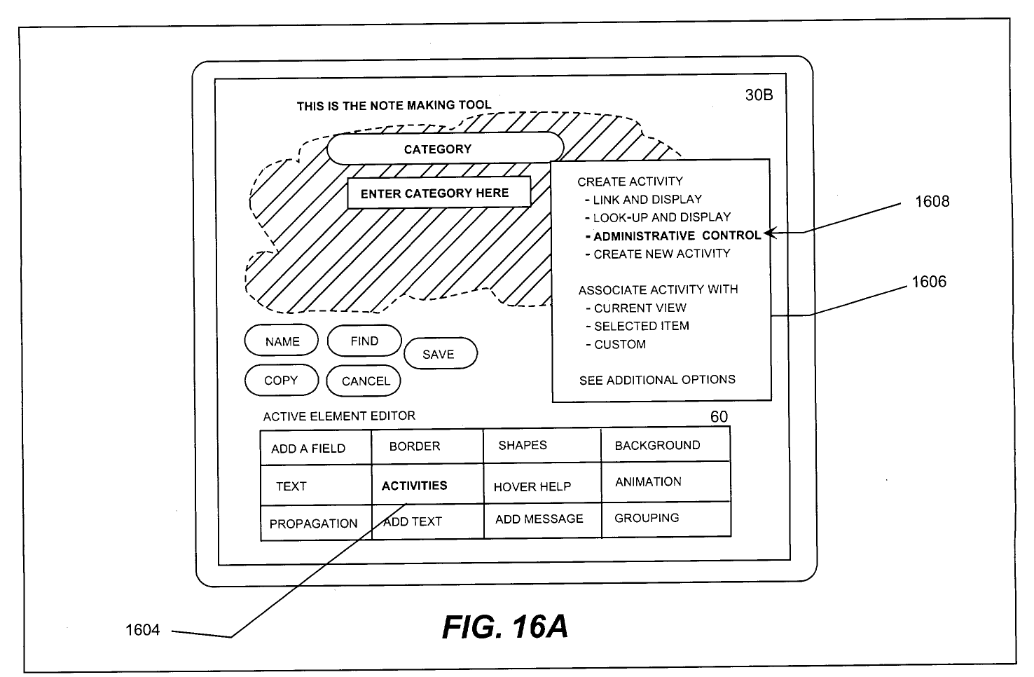

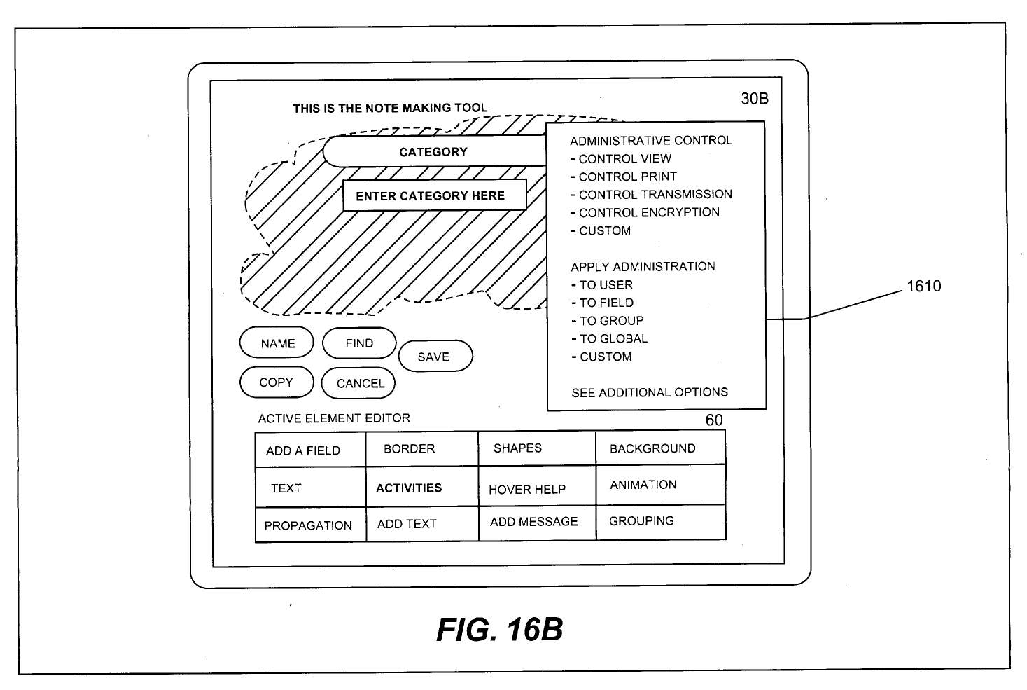

FIG. 16A illustrates an example of a user interface for adding an activity to a view. In particular, when the user selects the “activities” control item 1604 on the active element editor 60, a pop-up activities view 1606 appears, which provides a number of pre-defined functions for adding or changing an activity to a view. For example, the activities view 1604 allows the user to select an administrative control item 1608. The administrative control item 1608 allows the user to implement or change control functions, such as the ability to view items, print items, transmit items, and add encryption to items on an item-by-item, field-by-field, user-by-user, group or global basis.

After the user selects the administrative control item 1608 from the activities view 1606, as shown in FIG. 16A, the user enters an acceptance command, such as a double click, depressing the “enter” key, or entering some other suitable command to instruct the host computer to implement the function associated with the administrative control item 1608. This causes an administrative control view 1610 to appear, as shown in FIG. 16B. The administrative control view 1610 allows the user to enter commands to define an administrative control function, such as controlling encryption or the ability to view, print or transmit items on a user-by-user, field-by-field, group or global basis. Once the user has started the administrative control definition process, this initial screen or view may be followed by additional screens or views and other types of items to assist the user in defining the activity.

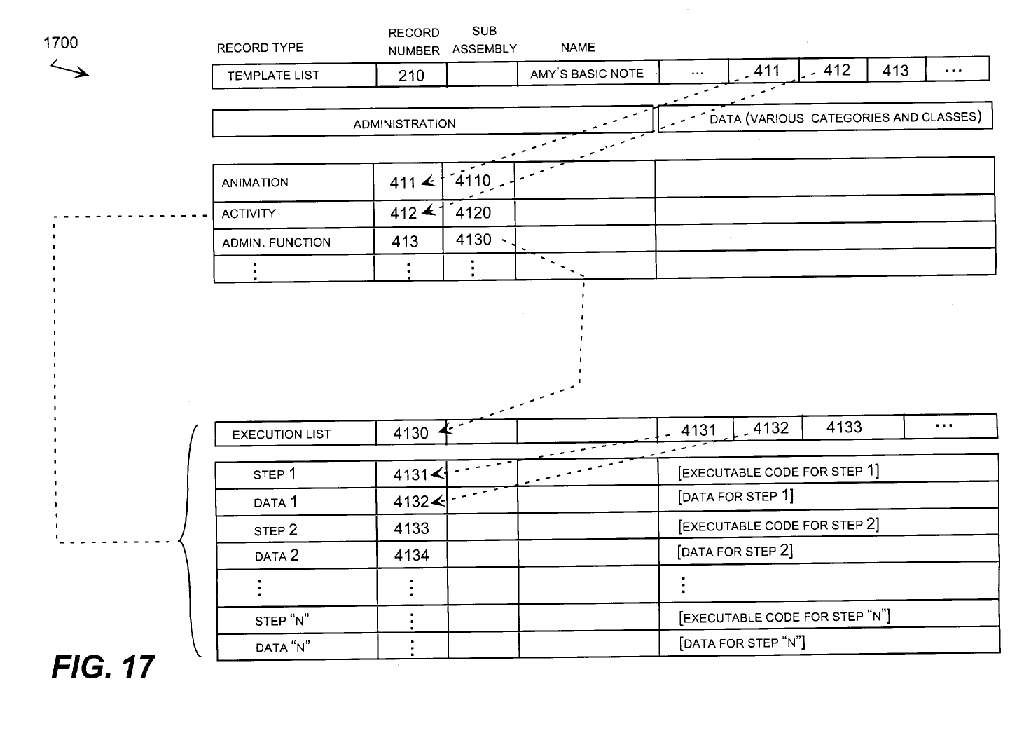

FIG. 17 is a block diagram illustrating a data structure 1700 for storing definition information for a view including an administrative control function. This data structure is a continuation of the data structure used to define the basic view shown in FIGS. 12A-B. In particular, the top-level template record 210 has been amended to identify a record 413 corresponding to an administration control function, as described with reference to FIGS. 16A-B. It should be appreciated that all of the various types of functionality described herein, such as this administrative control function and many more functions that will become apparent to those skilled in the art, may be implemented through database records using the basic techniques described for this example.

To illustrate the basic technique, the record 413 identified in the top-level record 210 has a corresponding sub-assembly record 4130 that identifies additional records that implement or incorporate aspects of the corresponding administrative control function. For example, the record 413, corresponding to the administrative control function, identifies the sub-assembly record 4130, which in turn identifies records 4131, 4132, 4133 and so forth. Each of these records, in turn, implements or incorporates an aspect of the administrative control function. For example, records 4131 and 4132 may be a field-parallel set of records containing code and associated data for implementing a first aspect of the administrative control function, such as restricting the display of certain fields in the view 30B to certain users. Similarly, records 4133 and 4134 may be a field-parallel set of records containing code and associated data for implementing another aspect of the of the administrative control function, such as restricting preventing certain users from printing or transmitting the view 30B to certain users.

In general, this process may be continued until the one or more complete administrative control functions is expressed in the form of database records. Once the administrative control function is expressed in this format, the database records may be processed, as described above with reference to FIG. 1, to implement the administrative control function when the associated view 30B, or an item within this view, is selected by the user. This same or a similar procedure may be used to implement encryption, animation, and all other effects described herein, on a user-by-user, field-by-field, group or global basis without the user having to resort to “programming” in the conventional sense, or having to interrupt the user session, for example to compile code. In addition, when the view is transmitted to another EXOBRAIN system, it will run properly, including the implementation of the administrative control function, without the receiving computer having to install new code or otherwise interrupt the user session.

In view of the foregoing, it will be appreciated that present invention provides an improved system for controlling administrative controls in a computer environment. It should be understood that the foregoing relates only to the exemplary embodiments of the present invention, and that numerous changes may be made therein without departing from the spirit and scope of the invention as defined by the following claims.

The invention claimed is:

1. A method for implementing administrative control functions in association with views for data items, comprising the steps of:
providing a view for displaying a data item;
receiving user commands defining an administrative control function to be performed in association the view;
storing information defining the administrative control function with reference to the data item; and
in response to a subsequent user command selecting the data item, implementing the administrative control function in association with the view.

2. The method of claim 1, wherein the steps are implemented during an uninterrupted user session.

3. The method of claim 1, wherein the administrative control function is defined by the user to be automatically implemented upon selection of the view.

4. The method of claim 1, further comprising the step of associating the administrative control function with multiple views.

5. The method of claim 1, further comprising the step of associating the administrative control function with a group of views identified by the user.

6. The method of claim 1, further comprising the steps of:
transmitting a view associated with the administrative control function to another computer comprising a compatible infrastructure; and
receiving the view, displaying the view, and implementing the administrative control function on the receiving computer during an uninterrupted user session.

7. The method of claim 1, wherein the administrative control function comprises controlling the ability of the identified users to display or change aspects of the view defined on an item-by-item, field-by-field, user-by-user, group or global basis, or combinations thereof.

8. The method of claim 1, wherein the administrative control function comprises the administration of encryption associated with transmission of the view.

9. The method of claim 8, wherein the encryption function is defined on an item-by-item, field-by-field, user-by-user, group or global basis, or combinations thereof.

10. The method of claim 1, wherein the information defining the administrative control function comprises sets of related data and software records expressed in field parallel format.

11. The method of claim 1, wherein the information defining the administrative control function comprises code incorporated into database records under the control of the user.

12. The method of claim 1, further comprising the steps of:
transmitting the database records defining a view associated with the administrative control function to another computer comprising a compatible set of executable code components; and
during an uninterrupted user session on the receiving computer:
receiving the database records defining the view; and
implementing the administrative control function.

13. A computer storage medium comprising computer-executable instructions for performing the method of claim 1.

14. An apparatus configured to perform the method of claim 1.

15. A method for implementing administrative control functions through database records, comprising the steps of:
providing a database for maintaining records;
receiving user commands defining a view for a data item incorporated into a record in the database;
creating a top-level record corresponding to the data item comprising a list of associated records;
creating a sub-level record corresponding to each record identified in the list, each sub-level record further defining an aspect of the view of the data item;
receiving user commands defining an administrative control function to be implemented in association with the view;
creating database records ultimately referenced to the top-level record defining the administrative control function;
storing the database records defining the administrative control function; and
in response to a subsequent user command selecting the view, implementing the administrative control function in association with the view.

16. The method of claim 15, wherein the records defining the administrative control function ultimately incorporate data components that cannot be subdivided without losing the entirety of the meaning of the original data.

17. The method of claim 15, wherein the records defining the administrative control function ultimately incorporate executable code components that cannot be subdivided without losing the entirety of the useful functionality of the original code.

18. The method of claim 15, wherein the records defining the administrative control function comprise sets of related data and software records expressed in field parallel format.

19. The method of claim 15, wherein the steps are implemented during an uninterrupted user session.

20. A computer storage medium comprising computer-executable instructions for performing the method of claim 15.

21. An apparatus configured to perform the method of claim 15.

22. A method for implementing administrative control function through database records, comprising the steps of:
providing a database for maintaining records;
providing a view for a data item incorporated into a record in the database;
providing a top-level record corresponding to the data item comprising a list of associated records;
providing a sub-level record corresponding to each record identified in the list, each sub-level record further defining an aspect of the view of the data item;
receiving user commands defining an administrative control function to be performed in association with the view;
creating database records ultimately referenced to the top-level record defining the administrative control function;
storing the database records defining the administrative control function; and
in response to a subsequent user command selecting the view, rendering the view and implementing the administrative control function in association with the view.

23. The method of claim 22, wherein the records defining the administrative control function ultimately incorporate:
data components that cannot be subdivided without losing the entirety of the meaning of the original data components; and
executable code components that cannot be subdivided without losing the entirety of the useful functionality of the original code.

24. The method of claim 22, wherein the records defining the administrative control function comprise sets of related data and software records expressed in field parallel format.

25. The method of claim 22, wherein the steps are implemented during an uninterrupted user session.

26. A computer storage medium comprising computer-executable instructions for performing the method of claim 22.

27. An apparatus configured to perform the method of claim 22.
